(19) United States
(12) Patent Application Publication
(10) Pub. No.: US 2006/0235956 A1
(43) Pub. Date: Oct. 19, 2006

(54) INFORMATION PROCESS DISTRIBUTION SYSTEM, INFORMATION PROCESSING APPARATUS AND INFORMATION PROCESS DISTRIBUTION METHOD

(75) Inventors: Hiroshi Kawaguchi, Tokyo (JP); Yoji Kawamoto, Tokyo (JP); Yutaka Nagao, Tokyo (JP); Koji Yoshimura, Tokyo (JP); Manabu Kimura, Tokyo (JP)

Correspondence Address: BELL, BOYD & LLOYD, LLC, P. O. BOX 1135, CHICAGO, IL, 60690-1135, US

(73) Assignee: Sony Corporation, Tokyo (JP)

(21) Appl. No.: 11/277,689

(22) Filed: Mar. 28, 2006

(30) Foreign Application Priority Data
Mar. 30, 2005 (JP) P2005-100177

(51) Int. Cl. G06F 15/16; G06F 15/173

(52) U.S. Cl. 709/223; 709/201

(57) ABSTRACT

An apparatus and method is disclosed wherein a process of information relating to a content which applies a high load to a CPU can be processed efficiently in a distributed manner. A request source information processing apparatus transmits a process type of the process to be executed, and receives identification information of different information processing apparatus in accordance with the process type and apparatus information associated with the identification information including resource information. Then, the request source apparatus acquires load information of the apparatus, and determines a particular apparatus to which a request to execute a process is to be issued based on the resource information and the load information. Then, the request source apparatus issues a request to execute the process and transmits information relating to the content to the particular apparatus.

### CROSS REFERENCES TO RELATED APPLICATIONS

The present application claims priority to Japanese Patent Application JP 2005-100177 filed in the Japanese Patent Office on Mar. 30, 2005, the entire contents of which is being incorporated herein by reference.

### BACKGROUND

This invention relates to an information process distribution system, and more particularly to an information process distribution system wherein information relating to a content is processed in a distributed manner by a plurality of information processing apparatus.

In recent years, digital contents such as music contents are subject to increasing illegal distribution and exchange without permission of the copyright together with popularization of the Internet and increase in speed and capacity of personal computers (PCs) and so forth. Thus, in order to prevent such illegal acts, a copyright protection technique for applying restrictions to distribution and utilization of contents is being spread.

In a copyright content management system which makes use a copyright protection technique, it is necessary to perform various processes such as encryption and decryption of a content, verification of a certificate necessary for utilization of the content and compression of music data. Such processes for utilization of a content protected by the copyright involve much processing which applies a high load to a central processing unit (CPU) of an information processing apparatus and provide a problem that the user response time to each process is elongated.

Further, a large number of information processing apparatus which can be connected to a network such as DVD recorders and audio apparatus are available recently in addition to PCs. Thus, various methods have been proposed wherein a plurality of information processing apparatus are connected to each other through a communication line to construct a home network so that resources of the information processing apparatus connected to the home network may be utilized effectively.

One of the methods is disclosed in Japanese Patent Laid-Open No. 2002-297559 wherein, when any of information processing apparatus connected to a network has a surplus CPU resource, the resource is lent to another information processing apparatus connected to the network. With the method, if one of such information processing apparatus lacks in resource, then it performs a process using a resource lent from another one of the information processing apparatus.

Another method is disclosed in Japanese Patent Laid-Open No. 2003-178036 wherein, if one of information processing apparatus connected to a network does not have a function required therefor, then it performs a process using the function provided in another one of the apparatus. With the method, when a request for a process to be performed using a function which is not provided in an apparatus is issued, the process can be executed using the function which is provided in another apparatus.

### SUMMARY

The information processing systems described merely allow utilization of a resource lent from another information processing apparatus or utilization of a function of another information processing apparatus with regard to a function which is not provided in an apparatus itself. However, the information processing systems have a problem in that the user response time to a process of a content protected under the copyright and providing a high load cannot be reduced.

It is desirable to provide an information process distribution system, an information processing apparatus and an information process distribution system which are novel and are improved in that a process of information relating to a content which applies a high load to a CPU can be processed efficiently in a distributed manner taking resource and load situations of a plurality of information processing apparatus connected to a network into consideration.

According to an embodiment of the present invention, there is provided an information process distribution system, including a management server, and a plurality of information processing apparatus connected to the management server through a communication network for processing information relating to a content, the management server including an apparatus information storage section for storing identification information of the information processing apparatus and apparatus information in an associated relationship with each other therein, the apparatus information including at least process types which can be executed individually by the information processing apparatus and resource information of the information processing apparatus, an information processing apparatus selection section for selecting one of the information processing apparatus suitable for a process type designated by a request source one of the information processing apparatus which issues a request to execute a process of information relating to a content and acquiring identification information of the selected information processing apparatus from the apparatus information storage section, and an apparatus information sender section for transmitting the identification information of the selected information processing apparatus acquired by the information processing apparatus selection section and the apparatus information associated with the identification information, the request source information processing apparatus including a process type sender section for transmitting a process type necessary to execute a process of information relating to a content, an apparatus information receiver section for receiving the identification information of the information processing apparatus selected by the management server and the apparatus information associated with the identification information, a load information acquisition section for acquiring load information of the selected information processing apparatus based on the identification information of the selected information processing apparatus received by the apparatus information receiver section, a request destination determination section for determining a request destination one of the information processing apparatus to which a request to execute a process is to be issued based on the resource information included in the apparatus information and the load information, and a content information sender section for issuing a request to execute the process to the request destination information processing apparatus and transmitting information relating to the content of an object of the process to be requested, the request destination information processing apparatus including a load information sender section for transmitting load information of the request destination information processing apparatus to the request source information processing apparatus, a process execution section for executing the process of the information relating to the content requested by the request source information processing apparatus, and a process execution result sender section for transmitting a result of the execution of the process executed by the content process execution section to the request source information processing apparatus.

In the information process distribution system, process types and resource information of the information processing apparatus connected to the network are stored into the management server, and one of the information processing apparatus suitable for a process type of a process to be executed by a request source one of the information processing apparatus which serves as a request source of a process relating to a content is selected. Then, the request source information processing apparatus acquires resource information and load information of those of the information processing apparatus selected by the management server and determines a request destination one of the information processing apparatus which is to serve as a request destination taking the resource information and the load information of the information processing apparatus itself and the different information processing apparatus into consideration. Consequently, when the request source information processing apparatus tries to execute a process which provides a heavy load and requires much time, it can distribute the process efficiently taking the resource information and the load information of the different information processing apparatus connected to the network into consideration. Since the request source information processing apparatus takes the resource information and the load information of the different information processing apparatus connected to the network into consideration every time it executes a process of information relating to a content, the calculation resources of the information processing apparatus which are connected to the network can be utilized effectively while the user is not aware of it, and reduction of the user response time can be achieved thereby.

According to another embodiment of the present invention, there is provided an information processing apparatus connected through a communication network to a management server and different information processing apparatus which process information relating to a content, including a process type sender section for transmitting a process type necessary to execute a process of information relating to a content, an apparatus information receiver section for receiving identification information of one, two or more of the different information processing apparatus suitable for the process type and apparatus information associated with the identification information and including at least resource information of the different information processing apparatus, a load information acquisition section for acquiring, based on the identification information of the different information processing apparatus received by the apparatus information receiver section, load information of the different information processing apparatus, a request destination determination section for determining a request destination one of the different information processing apparatus to which a request to execute a process is to be issued based on the resource information included in the apparatus information and the load information, and an information sender section for issuing a request to execute the process to the request destination information processing apparatus and transmitting information relating to the content of an object of the process to be requested.

In the information processing apparatus, when it executes a process of information of a content, it transmits a process type necessary to execute a process to be executed to the management server and acquires identification information and resource information of those of the different information processing apparatus which are suitable for the process type. Then, the information processing apparatus issues an enquiry about load information at present of the different information processing apparatus and determines the request destination information processing apparatus to which a request to execute the process is to be issued taking the resource information and the load information of the different information processing apparatus into consideration. Consequently, a process of information relating to a content can be distributed taking the resource information and the load information of the information processing apparatus connected to the network and including the information processing apparatus itself into consideration, and the calculation resources of the information processing apparatus which are connected to the network can be utilized effectively.

The information processing apparatus may be configured such that the management server stores identification information of the different information processing apparatus and apparatus information in an associated relationship with each other therein, the apparatus information including process types which can be executed individually by at least those of the different information processing apparatus which are associated with the identification information and resource information of the different information processing apparatus, and the management server selects one of the different information processing apparatus suitable to the process type transmitted thereto from the process type sender section and transmits the identification information of the selected information processing apparatus. In the information processing apparatus, apparatus information including resource information and so forth of the information processing apparatus which are connected to the network can be stored collectively in the management server. Consequently, the apparatus information stored in the management server can be provided in response to a request from the information processing apparatus which executes the process.

The information processing apparatus may further include a process execution acceptance permission/rejection enquiry section for issuing an enquiry about whether or not execution of the process of information relating to the content is acceptable to the different information processing apparatus associated with the identification information of the different information processing apparatus received by the apparatus information receiver section, the load information acquisition section acquiring load information of the different information processing apparatus which can accept execution of the process of information relating to the content. In the information processing apparatus, it can issue an enquiry about load information to only those of the different information processing apparatus which can accept execution of a process of information relating to a content. Consequently, a useless process can be eliminated.

The information processing apparatus may be configured such that the request destination determination section determines an execution ratio of the process and that one of the different information processing apparatus to which a request for the process according to the execution ratio is to be issued based on the resource information included in the apparatus information and the load information, and the information sender section issues a request for execution of the process to the determined different information processing apparatus and transmits information relating to the content of the object of the process according to the execution ratio. In the information processing apparatus, a process can be executed divisionally in response to the resource information and the load information of the information processing apparatus which are connected to the network. Consequently, a process of information relating to a content can be executed efficiently in a distributed fashion.

The information processing apparatus may further include an information encryption section for encrypting the information relating to the content of the object of the process to be requested with a user key unique to a user who uses the information processing apparatus, the information sender section transmitting the information relating to the content and encrypted by the information encryption section.

The encryption is to rearrange digital information using a cryptographic key. The user key and a device key hereinafter described are cryptographic keys. A cryptographic key is a predetermined rule used for the rearrangement of digital information. Two methods are available for a cryptographic key including public key cryptography which uses different keys for encryption and decryption and private key cryptography which uses the same key for encryption and decryption, and the present invention can be applied to both methods. It is to be noted that, in the present specification, the user key is a key provided to a user who utilizes the information process distribution system and includes a key for encryption and a key for decryption. The device key is a key provided to each information processing apparatus and includes both of a key for encryption and a key for decryption.

In the information processing apparatus, it can transmit and receive information relating to a content in safety to and from a different information processing apparatus connected to the network. Consequently, a process of information relating to a content can be executed in a distributed fashion while the copyright of the content is protected.

The information processing apparatus may further include a link information storage section for storing identification information of the information processing apparatus and identification information of the user who uses the information processing apparatus in an associated relationship with each other, the link information storage section storing an encrypted user key unique to the user who uses the information processing apparatus, and a key processing section for decrypting the encrypted user key using a device key unique to the information processing apparatus, the information encryption section encrypting the information relating to the content with the user key unique to the user and decrypted by the key processing section. In the information processing apparatus, only where it is associated with the user who uses the information processing apparatus, it can encrypt or decrypt information relating to a content. Consequently, a process of information relating to a content can be executed in a distributed fashion while the copyright of the content is protected.

The information processing apparatus may be configured such that the link information storage section stores at least one piece of link information and produces, in accordance with the stored link information, a route whose starting point is the information processing apparatus identified with the identification information and whose arriving point is the user identified with the identification information to implement the association between the identification information of the information processing apparatus and the identification information of the user who uses the information processing apparatus, the link information including a pair of pieces of identification information one of which represents a link source and the other one of which represents a link destination.

According to a further embodiment of the present invention, there is provided an information processing apparatus connected through a communication network to a different information processing apparatus which issues a request to process information relating to a content, including a load information sender section for transmitting load information of the information processing apparatus to the different information processing apparatus, a process execution section for executing the process of the information relating to the content requested by the different information processing apparatus, and a process execution result sender section for transmitting a result of the execution of the process executed by the content process execution section to the different information processing apparatus.

In the information processing apparatus, it can execute a process of information relating to a content requested by the different information processing apparatus in response to resource information and load information of the information processing apparatus itself. Consequently, when the load to the information processing apparatus itself is heavy, it does not execute the process of the different information processing apparatus, but when the information processing apparatus has a sufficient room in the resources thereof, it can execute the process of the different information processing apparatus. Consequently, the resources of the information processing apparatus which are connected to the network can be utilized effectively.

The information processing apparatus may further include a process execution acceptance permission/rejection decision section for deciding whether or not execution of the process of information relating to the content requested by the different information processing apparatus is acceptable, and an acceptance permission/rejection decision result sender section for transmitting a result of the acceptance permission/rejection decision decided by the process execution acceptance permission/rejection decision section to the different information processing apparatus, the load information sender section transmitting load information of the information processing apparatus when it is decided by the process execution acceptance permission/rejection decision section that execution of the process of information is acceptable. In the information processing apparatus, only when it can accept execution of the process of the different information processing apparatus, it can transmit load information of the information processing apparatus itself. Consequently, a useless process can be eliminated.

The information processing apparatus may further include an information receiver section for receiving information relating to a content of an object of processing encrypted with a user key unique to a user who uses the different information processing apparatus by the different information processing apparatus, and an information decryption section for decrypting the information relating to the encrypted content, the process execution section executing the process of the information relating to the content and decrypted by the information decryption section. Or, the information processing apparatus may further include a process execution result encryption section for encrypting a process execution result of the process executed by the process execution section with a user key unique to a user who uses the information processing apparatus, the process execution result sender section transmitting the process execution result encrypted by the process execution result encryption section. In the information processing apparatus, it can transmit and receive information relating to a content in safety to and from the different information processing apparatus connected to the network. Consequently, a process of information relating to a content can be executed in a distributed fashion while the copyright of the content is protected.

The information processing apparatus may further include a link information storage section for storing identification information of the information processing apparatus and identification information of a user who uses the information processing apparatus, the content decryption section successfully decrypting the encrypted information relating to the content when the identification information of the user stored in the link information storage section and identification information of a user who uses the different information processing apparatus. In the information processing apparatus, it successfully decrypts information relating to a content only when identification information corresponding to the identification information of a user who uses the different information processing apparatus is stored in the link information storage section. Consequently, a process of information relating to a content can be executed in a distributed fashion while the copyright of the content is protected.

The information processing apparatus may further include a link information storage section for storing identification information of the information processing apparatus and identification information of the user who uses the information processing apparatus in an associated relationship with each other, the link information storage section storing an encrypted user key unique to the user who uses the information processing apparatus, and a key processing section for decrypting the encrypted user key using a device key unique to the information processing apparatus, the information decryption section decrypting the encrypted information relating to the content with the user key decrypted by the key processing section. In the information processing apparatus, it can encrypt or decrypt information relating to a content only when the information processing apparatus and the user who uses the information processing apparatus are associated with each other. Consequently, a process of information relating to a content can be executed in a distributed fashion while the copyright of the content is protected.

The information processing apparatus may be configured such that the link information storage section stores at least one piece of link information and produces, in accordance with the stored link information, a route whose starting point is the information processing apparatus identified with the identification information and whose arriving point is the user identified with the identification information to implement the association between the identification information of the information processing apparatus and the identification information of the user who uses the information processing apparatus, the link information including a pair of pieces of identification information one of which represents a link source and the other one of which represents a link destination.

Also information processing distribution methods for distributing an information process are provided.

With the information process distribution system, information processing apparatus and information process distribution methods, a process of information relating to a content which applies a heavy load to a CPU can be executed efficiently in a distributed fashion taking resource and load situations of a plurality of information processing apparatus connected to a network into consideration.

The above and other objects, features and advantages of the present invention will become apparent from the following description and the appended claims, taken in conjunction with the accompanying drawings in which like parts or elements denoted by like reference symbols.

Additional features and advantages are described herein, and will be apparent from, the following Detailed Description and the figures.

### BRIEF DESCRIPTION OF THE FIGURES

FIG. 1 is a schematic view showing an outline of a link system of a content providing system in which an information process distribution system according to the present invention is applied and illustrating copyright management of the link system.

FIG. 2 is a schematic view showing a general configuration of the content providing system of FIG. 1.

FIG. 3 is a block diagram schematically showing an example of a hardware configuration of a PC shown in FIG. 1.

FIG. 4 is a block diagram schematically showing an example of a hardware configuration of a PD shown in FIG. 1.

FIG. 5 is a block diagram showing a functional configuration of a copyright management server shown in FIG. 2.

FIG. 6 is a view illustrating the stored substance of a user information storage section shown in FIG. 5.

FIG. 7 is a timing chart illustrating a registration process of the PC shown in FIG. 1.

FIG. 8 is a timing chart illustrating a registration process of the PD shown in FIG. 1.

FIG. 9 is a timing chart illustrating a registration process of a user in the content providing system of FIG. 1.

FIG. 10 is a timing chart illustrating a link process of the content providing system of FIG. 1.

FIG. 11 is a diagrammatic view illustrating the substance of link information used in the content providing system of FIG. 1.

FIG. 12 is a timing chart illustrating another link process of the content providing system of FIG. 1.

FIG. 13 is a view illustrating key information included in a link used in the content providing system of FIG. 1.

FIG. 14 is a timing chart illustrating a license issuance process of the content providing system of FIG. 1.

FIG. 15 is a diagrammatic view illustrating the substance of license information used in the content providing system of FIG. 1.

FIG. 16 is a block diagram showing a functional configuration of a content reproduction apparatus shown in FIG. 1.

FIG. 17 is a block diagram showing a more detailed configuration of the content reproduction apparatus shown in FIG. 16.

FIG. 18 is a flow chart illustrating a content key decryption permission/inhibition decision process by the content reproduction apparatus of FIG. 16.

FIG. 19 is a flow chart illustrating a content reproduction process by the content reproduction apparatus of FIG. 16.

FIG. 20 is a diagrammatic view illustrating a concept of key information used in the content providing system of FIG. 1.

FIG. 21 is a block diagram showing a general configuration of the information process distribution system according to the present invention.

FIG. 22 is a block diagram showing a functional configuration of a management server and a request source information processing apparatus shown in FIG. 21.

FIG. 23 is a block diagram showing a functional configuration of a request destination information processing apparatus shown in FIG. 21.

FIG. 24 is a timing chart illustrating a distributed processing method used in the information process distribution system of FIG. 21.

FIG. 25 is a view illustrating information stored in an apparatus information storage section shown in FIG. 22.

FIG. 26 is a view illustrating information included in load information used in the information process distribution system of FIG. 21.

FIG. 27 is a flow chart illustrating a method of decrypting information relating to a content used in the information process distribution system of FIG. 21.

### DETAILED DESCRIPTION

In the following, an information process distribution system according to the present invention is applied to an information process distribution system 500 which can process information relating to a content protected by the copyright efficiently in a distributed fashion.

The content may be an arbitrary content such as, for example, a sound (Audio) content of music, a lecture, a radio program or the like, an image (Video) content formed from a still picture or pictures or moving pictures which form a movie, a television program, a video program, a photograph, a painting, a chart or the like, an electronic book (E-book), a game or software. In the following description, a sound content, particularly a music content distributed from a distribution server or ripped from a music CD, is described as an example of a content. However, the present invention is not limited to such an example as just mentioned.

The process of information relating to a content includes encryption and decryption of the content or a content key for encrypting the content, verification of a certificate necessary for utilization of the content, compression of music data and so forth. Such processes involve much processing which applies a high load to a CPU of the information processing apparatus and provide a problem that the user response time to each process is elongated.

Although it is necessary to protect the copyright of a content in order to prevent an illegal act, if much time is required for such processes as described above when a content protected by the copyright is utilized, then distribution of the content is disturbed.

Recently, various apparatus are utilized by users to reproduce a content, and it has become possible to connect an apparatus to a network to download a content or connect different apparatus to each other to transmit and receive information relating to a content through a network.

Thus, in the information process distribution system of the present embodiment, processes of information relating to a content which apply a high load to a CPU are distributed to information processing apparatus connected to each other by a network to achieve efficient distributed processing over the overall network.

An outline of the information process distribution system 500 of the present embodiment is described above. In the following, copyright management by a link system which is adopted by the information process distribution system 500 according to the present embodiment is described. According to the copyright management of the link system, the copyright of a content can be protected and also information relating to the content can be transmitted and received in safety.

<1. Outline of the Copyright Management by the Link System>

First, an outline of a content providing system ready for the copyright management by the link system used in the information process distribution system according to the present embodiment is described.

The content providing system manages users and utilization conditions of copyright management contents (hereinafter referred to simply as “contents”) obtained by encrypting digital contents of images, sound and so forth. The content providing system restricts utilization of a content by any other user than the user who purchases the content in order to prevent illegal utilization of the content such as an act of mass distribution of the content through the Internet or the like with certainty.

In order for a user who purchases an encrypted content to reproduce the content, it is necessary to decrypt the content with a content encryption processing key (hereinafter referred to as “content key”) used to encrypt the content. Even if the content is distributed illegally through the Internet or the like, if the content key is not available, then the content cannot be reproduced. Accordingly, in the content providing system, a content key must be distributed in safety and must be used by a legal user.

On the other hand, between apparatus owned by a user who purchases a content, it is necessary to permit the content to be distributed freely to some degree. Otherwise, the user who purchases the content cannot reproduce the content on an apparatus owned by the user itself or can be reproduced but only by an apparatus together with which the content is purchased.

In this manner, the content providing system adopts a copyright management system wherein, while copyright management is performed, sharing of a content can be permitted within the range of private utilization to enhance the convenience and degree of freedom in content sharing among a plurality of apparatus owned by the same user. In order to implement the copyright management system, in the present embodiment, a copyright management scheme by the link system is adopted.

According to the copyright management by the link system, difference apparatus are associated with each other to make it possible to share a content among the apparatus. In the present embodiment, to associate different apparatus with each other is referred to as to link apparatus (to each other). For example, by linking an apparatus 2 owned by a user to another apparatus 1 owned by the user, it becomes possible to reproduce a content, which can be reproduced on the apparatus 1, also on the apparatus 2. While detailed description of the apparatus is hereinafter given, any apparatus linked to the apparatus 1 which can reproduce a content can reproduce the content, but any apparatus which is not linked to the apparatus 1 cannot reproduce the content. Therefore, while copyright management is performed, a content can be reproduced freely to some degree by any apparatus owned by the user.

It is to be noted that the content may be an arbitrary content such as, for example, a sound (Audio) content of music, a lecture, a radio program or the like, an image (Video) content formed from a still picture or pictures or moving pictures which form a movie, a television program, a video program, a photograph, a painting, a chart or the like, an electronic book (E-book), a game or software. In the following description, a music content, particularly a music content distributed from a distribution server or ripped from a music CD, is described as an example of a content. However, the present invention is not limited to such an example as just mentioned.

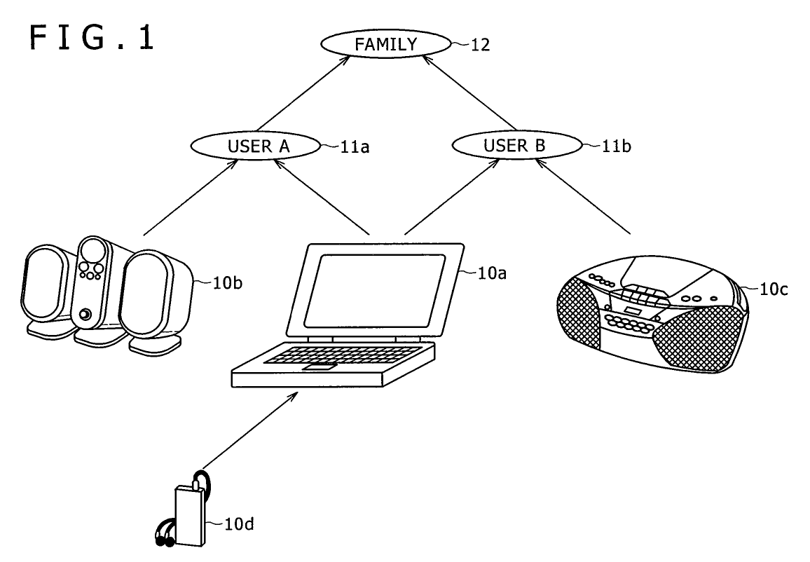

Now, an outline of the link system in the content providing system for performing such copyright management of the link system as described above is described with reference to FIG. 1. FIG. 1 shows an outline of the link system of the content providing system.

Referring to FIG. 1, it is assumed that a user A 11a owns user apparatus 10a, 10b and 10d. For example, the user A subscribes for a content providing service through the user apparatus 10a and purchases a content. If the user A wants to reproduce the content on the user apparatus 10a which is an apparatus owned by the user A itself, then the user A would link the user apparatus 10a to the user A. As described hereinabove, if the user apparatus 10a is linked to the user A, then it becomes possible for a content purchased by the user A to be reproduced on the user apparatus 10a.

Here, to link the user apparatus 10a to the user A is that the user apparatus 10a acquires private information of the user A. The private information of the user A is information which can be known originally by the user A and is, for example, information of a private key of the user A. For example, in order to distribute a content key in safety to the user A, the content key is encrypted with a public key or a private key of the user and distributed to the user A.

The user A would try to reproduce a content on the user apparatus 10a. However, if the user apparatus 10a does not have information of the private key of the user A, then the user apparatus 10a cannot decrypt the content key and hence cannot reproduce the content. Therefore, if the user apparatus 10a is linked to the user A, that is, if the user apparatus 10a can acquire the information of the private key of the user A, then the user apparatus 10a can reproduce the content purchased by the user A.

Similarly, the user apparatus 10b would be linked to the user A. If the user apparatus 10b has the information of the private key of the user A, then also the user apparatus 10b can reproduce any content purchased by the user A.

In order for the private key of the user A to be distributed in safety to the user apparatus 10a, it is necessary for the private key of the user A to be encrypted with the public key or the private key of the user apparatus 10a and distributed to the user apparatus 10a. The private key of the user A is decrypted by the user apparatus 10a, and the content key is decrypted with the decrypted private key of the user A. Further, if it is desired to reproduce the content also on the user apparatus 10d, the user apparatus 10d should be linked to the user apparatus 10a. The user apparatus 10d can acquire the information of the private key of the user apparatus 10a and can acquire also the information of the private key of the user A using the private key of the user apparatus 10a. Then, the content purchased by the user A can be reproduced with the private key of the user A.

In this manner, if an apparatus acquires private information of a link destination tracing the destinations of the links to which the apparatus itself is linked, then the apparatus at the link destination can reproduce a content purchased. For example, if the user apparatus 10a is linked to a user B 11b who is a member of a family 12 of the user A, then also a content purchased by the user B can be reproduced on the user apparatus 10a. Further, if the user A and the user B are linked to a different member of the family, then when the member of the family becomes a member of the content providing service and purchases a content, also the user A and the user B can reproduce the content. Then, if any user apparatus is linked to the user A and the user B, then the user apparatus can reproduce the content purchased by the member of the family.

Furthermore, if users and user apparatus owned by the users or user apparatus owned by users are linked to each other, then only if a content key is distributed in safety to any of the users, then it is possible to restrict those users who utilize the content while the content is shared freely to some degree between the apparatus owned by the users.

An outline of the copyright management by the link system is described above. Now, the content providing system 100 as a particular example which implements the copyright management by the link system is described below.

<2. General Configuration of the Content Providing System>

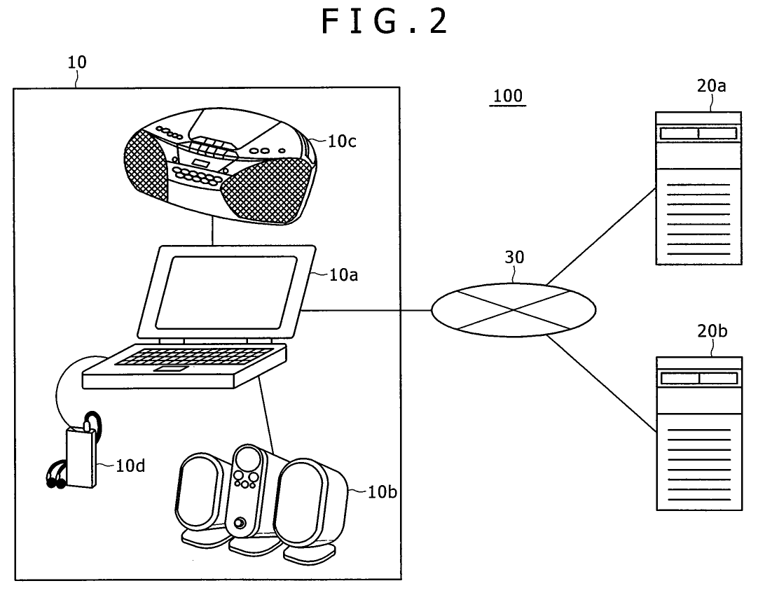

FIG. 2 shows a general configuration of the content providing system 100. Referring to FIG. 2, the content providing system 100 shown includes user apparatus 10, a copyright management server 20a, and a content providing server 20b. The user apparatus 10 may include a plurality of user apparatus 10a, 10b, 10c, 10d, . . . as described hereinabove. Further, while the copyright management server 20a and the content providing server 20b are formed as separate servers from each other, they may otherwise be formed as a single synthesized server.

Various information processing apparatus for utilizing a content can be used for the user apparatus 10. In FIG. 2, the user apparatus 10 includes a personal computer (hereinafter referred to sometimes as PC) 10a of the notebook type or the desk top type, audio apparatus 10b and 10c, and a portable device (hereinafter referred to sometimes as PD) 10d which is a content reproduction apparatus of the portable type.

The user apparatus 10 have, for example, utilization functions of a content (for example, reproduction, storage, movement, joining, dividing, conversion, duplication, lending and returning functions of a content), a content reproduction controlling function based on a link described hereinabove, a management function of a content (for example, search and deletion functions of a content based on a content ID, a content key or the like), and a content production function by ripping, self recording and the like.

From among the user apparatus 10, an apparatus (for example, the user apparatus 10a) which has a communication function through a network 30 can be connected for communication to the copyright management server 20a and the content providing server 20b. Any user apparatus 10 of the type described can download and install software for a content distribution service and software for copyright management, for example, from the content providing server 20b. Consequently, the user apparatus 10 can receive an encrypted content distributed from the content providing server 20b or receive a license including a content key for a content, utilization conditions of the content and so forth and distributed from the copyright management server 20a. Further, the user apparatus 10 can record received data into a storage device or a storage element such as a removable storage medium.

Further, the user apparatus 10 can newly produce a content, for example, by self recording (self recording of sound, images or the like) or ripping and record the produced content into the storage device or a removable storage medium. It is to be noted that the term “self recording” signifies recording of an image picked up by an image pickup apparatus and/or sound collected by a sound collecting apparatus which the user apparatus 10 itself has as digital data of the image and/or sound. Meanwhile, the term “ripping” is to extract a digital content (sound data, image data or the like) recorded in a storage medium such as a music CD, a video DVD or a software CD-ROM, convert the digital content into data of a file format with which the data can be processed by a computer, and record the data obtained by the file format conversion into a storage device or a removable recording medium.

Where the user apparatus 10b, 10c and 10d are linked to the user apparatus 10a in such a manner as described above, a content downloaded into and capable of being reproduced by the user apparatus 10a can be reproduced also by any of the user apparatus linked to the user apparatus 10a. If any of the user apparatus 10 tries to reproduce a content, then a content key used to encrypt the content is required. Also the content key is in an encrypted form, and if the user apparatus 10a acquires a key used to encrypt the content key, then it can decrypt the content key, decrypt the content with the content key and then reproduce the content by the user apparatus 10 itself.

The copyright management server 20a is an information processing apparatus which transmits a content key in safety to a user so that a link process for allowing a content to be shared by apparatus owned by the user may be performed while restricting reproduction of the content. In particular, the copyright management server 20a performs a registration process of a user and user apparatus 10 owned by the user, performs linking of the user and the user apparatus or linking between the user apparatus, and encrypts and transmits a content key to the user apparatus 10.

The content providing server 20b is a server for providing contents and provides a content providing service to users. The content providing server 20b distributes, in response to a request from a user apparatus 10, a content to the user apparatus 10 through the network 30.

For example, when music contents are to be distributed, the content providing server 20b is formed as a server for providing an electronic music distribution (EMD) service. In this instance, the content providing server 20b compression codes a music content of a distribution object, for example, in accordance with the ATRAC3 (Advanced Transform Acoustic Coding) method or the MP3 (MPEG Audio Layer-3) method, encrypts the compression coded music content in accordance with an encryption method such as the DES (Data Encryption Standard) and distributes the encrypted music content to the user apparatus 10. Further, the content providing server 20b may encrypt and transmit a content key for decrypting the content to the user apparatus 10 together with the content encrypted in this manner. Furthermore, the content providing server 20b may provide the content key to the copyright management server 20a so that the copyright management server 20a may encrypt and transmit the content key to the user apparatus 10.

The content providing server 20b may be formed also as a server which provides a production content utilization service for managing utilization of a content produced by ripping, self recording or the like by a user apparatus 10 itself. In this instance, the content providing server 20b distributes a content key for decrypting the content to the user apparatus 10. Consequently, the user apparatus 10 can reproduce the content produced by ripping or the like by the user apparatus 10 itself using the content key acquired from the content providing server 20b.

The network 30 is a communication network for interconnecting the user apparatus 10, copyright management server 20a and content providing server 20b for communication therebetween. The network 30 may be formed from a public network such as the Internet, a telephone network or a satellite communication network, a dedicated network such as a WAN, a LAN or an IP-VPN and may be any of a wire network and a wireless network.

The content providing system 100 described above has a copyright management function of restricting the utilization of a content while it can enhance the portability of a content between the various user apparatus 10 to enhance the convenience to users and the degree of freedom in utilization of contents.

<3. Hardware Configuration of the User Apparatus>

Now, the hardware configuration of the user apparatus 10 according to the present embodiment is described. In the following, description is given of an example of the hardware configuration of the PC 10a and the PD 10d as representative ones of the user apparatus 10. It is to be noted that the PC 10a and the PD 10d as the user apparatus 10 are configured as different forms of the content processing apparatus of the present invention.

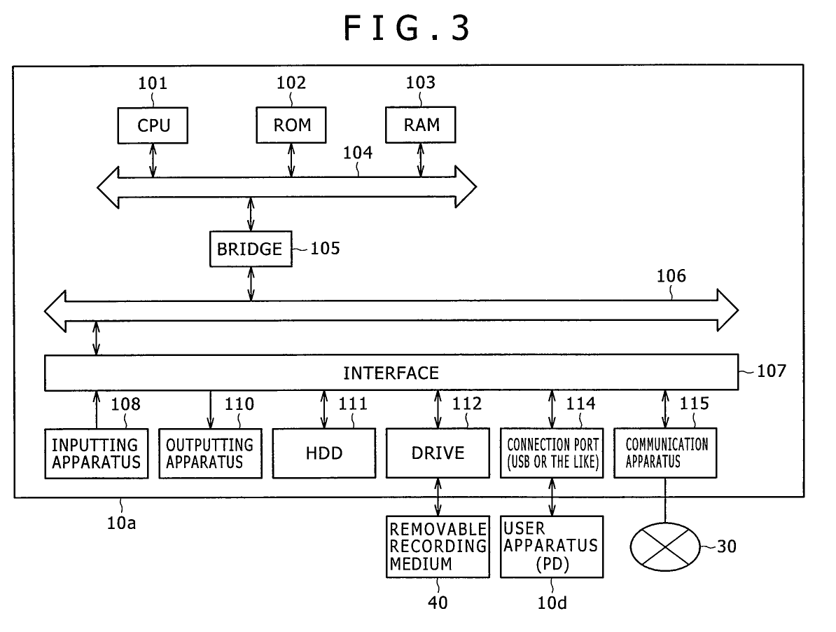

First, the hardware configuration of the PC 10a according to the present embodiment is described with reference to FIG. 3. FIG. 3 schematically shows an example of a hardware configuration of the PC 10a according to the present embodiment.

As shown in FIG. 3, the PC 10a includes, for example, a CPU (Central Processing Unit) 101, a ROM (Read Only Memory) 102, a RAM (Random Access Memory) 103, a host bus 104, a bridge 105, and an external bus 106. The PC 10a further includes an interface 107, an inputting apparatus 108, an outputting apparatus 110, a storage apparatus (hard disk drive: HDD) 111, a drive 112, a connection port 114, and a communication apparatus 115.

The CPU 101 functions as an arithmetic operation processing apparatus and a control apparatus and operates in accordance with the programs stored in the ROM 102 or the HDD 111 to control the components of the PC 10a. The particular processes executed by the CPU 101 include, for example, encryption and decryption processes of a content, production and verification processes of a digital signature (MAC (Message Authentication Code) or the like) for data falsification prevention and data verification, authentication and session key sharing processes executed upon inputting or outputting of a content or the like from or to another user apparatus 10 connected to the PC 10a, input and output process control of a content, a license, a content key or the like, a copyright management process such as license evaluation and other necessary processes.

The ROM 102 stores programs, arithmetic operation parameters and so forth to be used by the CPU 101. The ROM 102 may be utilized also as a storage element for storing a content, a license, a content key and so forth. The RAM 103 temporarily stores a program to be used for execution by the CPU 101, parameters which vary suitably during the execution and so forth. The CPU 101, ROM 102 and RAM 103 are connected to each other by the host bus 104 formed from a CPU bus or the like.

The host bus 104 is connected through the bridge 105 to the external bus 106 such as a PCI (Peripheral Component Interconnect/Interface) bus or the like.

The inputting apparatus 108 is formed from inputting elements such as, for example, a mouse, a keyboard, a touch panel, buttons, switches and levers, an input control circuit for producing and outputting an input signal to the CPU 101, and so forth. The user of the PC 10a can operate the inputting apparatus 108 to input various data to the PC 10a and issue an instruction of a processing operation to the PC 10a.

The outputting apparatus 110 is formed from a display apparatus such as, for example, a CRT (Cathode Ray Tube) display apparatus, a liquid crystal display (LCD) apparatus, lamps or the like and a sound outputting apparatus such as a speaker. The outputting apparatus 110 outputs, for example, a reproduced content. In particular, the display apparatus displays a reproduced image content as moving pictures or still pictures in the form of a text or an image. Meanwhile, the sound outputting apparatus emits sound of a reproduced sound content.

The HDD 111 is an apparatus for data storage formed as an example of a storage section of the PC 10a according to the present embodiment. The HDD 111 stores programs to be executed by the CPU 101 and various data on a hard disk. Further, various data, for example, of contents, licenses and content keys are stored in the HDD 111.

The drive 112 is a reader/writer for a storage medium and is built in or externally provided for the PC 10a. The drive 112 records/reproduces various data of contents, licenses and content keys on/from a removable recording medium 40 such as a magnetic disk (HD or the like), an optical disk (CD, DVD or the like), a magneto-optical disk (MO or the like) or a semiconductor memory loaded in the PC 10a.

In particular, the drive 112 reads out data recorded on the removable recording medium 40 and supplies the data to the RAM 103 through the interface 107, external bus 106, bridge 105 and host bus 104. The CPU 101 stores the data into the RAM 103, the HDD 111 or the like as occasion demands. On the other hand, the drive 112 receives data stored in the RAM 103, the HDD 111 or the like, data newly produced or data acquired from an external apparatus from the CPU 101 and writes the data on the removable recording medium 40.

The connection port 114 is a port for connecting the PC 10a to an external peripheral apparatus such as, for example, another user apparatus 10 and has connection terminals such as USB terminals, IEEE1394 terminals or the like. The connection port 114 is connected to the CPU 101 and so forth through the interface 107, external bus 106, bridge 105, host bus 104 and so forth. By such a connection port 114 as just described, the PC 10a is connected to the user apparatus 10d and so forth through a local line and can communicate various data to and from the PD 10d and so forth.

The communication apparatus 115 is a communication interface formed from a communication device or the like for connecting, for example, to the network 30. The communication apparatus 115 transmits and receives various data of a content, a content key and so forth to and from an external apparatus such as another user apparatus 10, the copyright management server 20a or the content providing server 20b through the network 30.

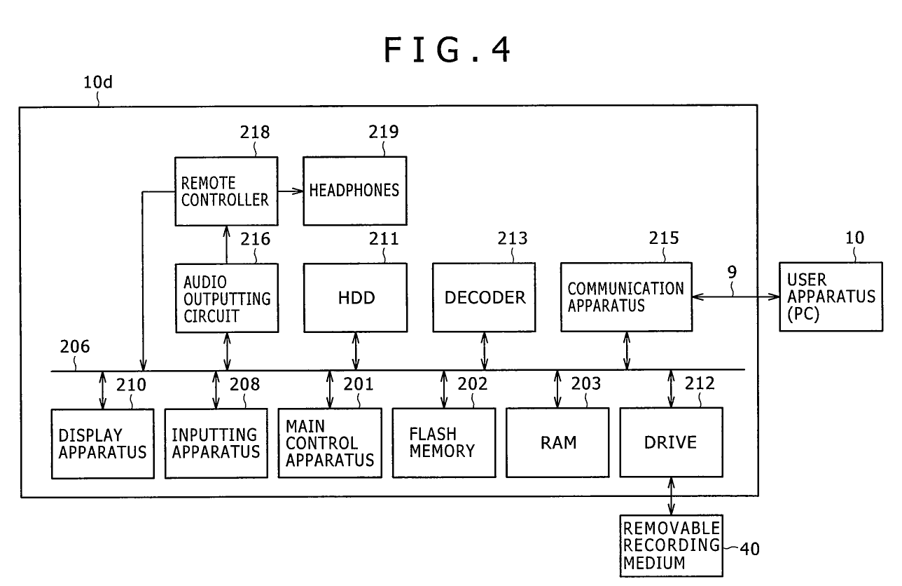

Now, a hardware configuration of the PD 10d according to the present embodiment is described in detail with reference to FIG. 4. FIG. 4 is a block diagram schematically shows an example of a hardware configuration of the PD 10d according to the present embodiment.

As shown in FIG. 4, the PD 10d includes, for example, a control apparatus 201, a flash memory 202, a RAM 203, a bus 206, an inputting apparatus 208, a display apparatus 210, a HDD 211, a drive 212, a decoder 213, a communication apparatus 215, an audio outputting circuit 216, a remote controller 218, and a headphones 219.

The control apparatus 201 operates in accordance with various programs, for example, stored in the flash memory 202 or the HDD 211 and controls the components of the PD 10d. The flash memory 202 stores, for example, a program which defines action of the control apparatus 201 and various data. The flash memory 202 can be utilized also as a storage section for storing a content, a license, a content key and so forth. Meanwhile, the RAM 203 is formed from, for example, an SDRAM (Synchronous DRAM) and temporarily stores various data relating to processes of the control apparatus 201.

The bus 206 is a data line which interconnects the control apparatus 201, flash memory 202, RAM 203, inputting apparatus 208, display apparatus 210, HDD 211, drive 212, decoder 213, communication apparatus 215, audio outputting circuit 216 and so forth.

The inputting apparatus 208 and the remote controller 218 are formed from operation elements such as, for example, a touch panel, button keys, levers, dials and so forth, and an input control circuit which produces an input signal in response to an operation of any of the operation elements by the user and outputs the input signal to the control apparatus 201. The user of the user apparatus 10 can input various data or input a processing action instruction to the user apparatus 10 by operating the inputting apparatus 208 or the remote controller 218 which is hereinafter described.

The display apparatus 210 is formed from, for example, an LCD panel, an LCD control circuit and so forth. The display apparatus 210 displays various kinds of information in the form of a text or an image under the control of the control apparatus 201.

The HDD 211 is an apparatus for data storage formed as an example of a storage section of the PD 10d according to the present embodiment. The HDD 211 is formed from, for example, a hard disk drive (HDD) having a storage capacity of several tens GB and stores contents, licenses, content keys, programs of the control apparatus 201 and various data. The PD 10d including the HDD 211 described above is formed as a content recording and reproduction apparatus which can record and reproduce a content. Consequently, the PD 10d can store not only a content provided from the PC 10a through the removable recording medium 40 but also a content received from the PC 10a or the like through a local line into the HDD 211 and reproduce the content. However, the present invention is not limited to the specific example just described above, but the PD 10d may be configured, for example, as an apparatus for exclusive use for reproduction of a content without including the HDD 211. In this instance, the PC 10a can read out, for example, a content stored in the removable recording medium 40 and execute only reproduction of the content (cannot perform recording).

The drive 212 is a reader/writer for a storage medium and is built in the PD 10d. The drive 212 records/reproduces various data of a content, a license, a content key and so forth on/from the removable recording medium 40 loaded in the user apparatus 10b. The decoder 213 performs a decryption process, a decoding process, a surround process, a conversion process into PCM data and so forth of an encrypted content.

The communication apparatus 215 is formed from a USB controller, a USB terminal and so forth and transmits and receives various data of a content, a license, a control signal and so forth to and from a user apparatus 10 such as the PC 10a connected through the local line such as a USB cable.

The audio outputting circuit 216 amplifies analog audio data decoded by the decoder 213 and DA converted by the control apparatus 201 and outputs the amplified analog audio data to the remote controller 218. The analog audio data are outputted from the remote controller 218 to the headphones 219 and outputted as sound from a speaker (not shown) built in the headphones 219.

An example of a hardware configuration of the PC 10a and the PD 10d which are examples of the user apparatus 10 is described above with reference to FIGS. 3 and 4. However, the user apparatus 10 which utilize a content are not limited to the examples of the PC 10a and the PD 10d described above but may include such various apparatus as a sound player of the installed type or as other electronic apparatus or information processing apparatus such as a television apparatus or a portable telephone set. Accordingly, each of the user apparatus 10 executes processes according to a hardware configuration unique to the apparatus.

<4. Functional Configuration of the Copyright Management Server>

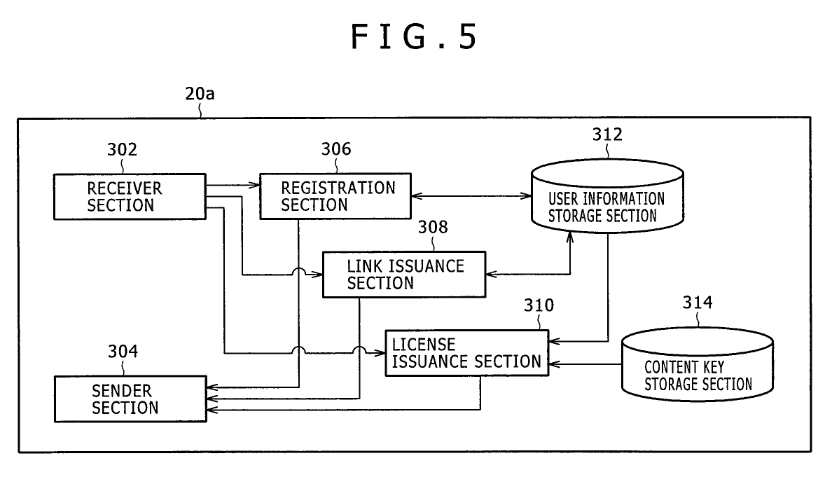

Now, a functional configuration of the copyright management server 20a is described with reference to FIG. 5. The copyright management server 20a includes a receiver section 302, a sender section 304, a registration section 306, a link issuance section 308, a license issuance section 310, a user information storage section 312, a content key storage section 314 and so forth.

The receiver section 302 is a communication interface formed from, for example, a communication line, a communication circuit, a communication device and so forth. The receiver section 302 receives attribute information of the user apparatus 10 connected to the copyright management server 20a through the network 30 and further receives information inputted to the user apparatus 10.

The registration section 306 performs a registration process of a new user who wants to utilize the content providing service and/or the copyright management service, a registration alteration process, a registration cancellation process, management of user account information (user ID, credit number, password and so forth) and so forth. To each user who is registered for any of the services, a key unique to the user is provided. The key provided here may be a public key and a private key paired with each other and used for public key cryptography or a common key used for private key cryptography. The key information is stored into the user information storage section 312 together with the user ID.

The registration section 306 further performs management of user apparatus owned by the user. The registration section 306 acquires particular information of a user apparatus (type, model, version and so forth of the apparatus) through the receiver section 302 and provides a device ID and a key unique to the user apparatus. Here, the device ID is identification information with which the user apparatus can be specified uniquely. The device ID may be a device ID set to the user apparatus in advance so that the user apparatus may be managed with the device ID.

In this manner, the key information provided by the registration section 306 is stored in an associated relationship with the user ID or the device ID into the user information storage section 312, and node information is produced from the user ID or the device ID and the key information. Then, the node information is transmitted to the user or the user apparatus through the sender section 304. The user or the user apparatus receives the node information and acquires an ID identified uniquely in the copyright management server 20a.

The key provided by the registration section 306 is used to encrypt a content key by the server or to decrypt a content key encrypted by a user apparatus. For example, if the server encrypts a content key with a public key of the user, then the user receiving the content key must decrypt the content key with a private key of the user. Accordingly, in this instance, it is necessary to transmit the private key of the user to the user in advance.

The link issuance section 308 has a function of associating a user and a user apparatus owned by the user with each other or associating user apparatus owned by the user with each other. In particular, the link issuance section 308 produces link information for linking a user apparatus to the user in response to an input from the user apparatus and transmits the link information to the user apparatus. The link issuance section 308 stores the link information also into the user information storage section 312. For example, it is assumed that a user who registers itself into the copyright management service wants to freely reproduce a content purchased by the user on three user apparatus owned by the user. The user would transmit a link request of the three user apparatus owned by the user itself to the copyright management server 20a. The link issuance section 308 of the copyright management server 20a receiving the link request links the user and the three user apparatus owned by the user to each other.

Here, to link the user and the three user apparatus to each other is to encrypt the private key of the user stored in the user information storage section 312 with public keys of the individual user apparatus. Where the content key for decrypting a content purchased by the user is encrypted with a private key, the encrypted content key cannot be decrypted without the private key of the user. However, if the user apparatus owned by the user are linked to the user, then any of the user apparatus owned by the user can acquire the private key of the user and decrypt the content key using the acquired private key. Further, the user apparatus can decrypt the encrypted content with the decrypted content key and reproduce the content.

The user information storage section 312 stores the key information and the link information in an associated relationship with the user ID and the device IDs. By acquiring the user ID or any of the device IDs, the copyright management server 20a can acquire key information corresponding to each user or user apparatus stored in the user information storage section 312.

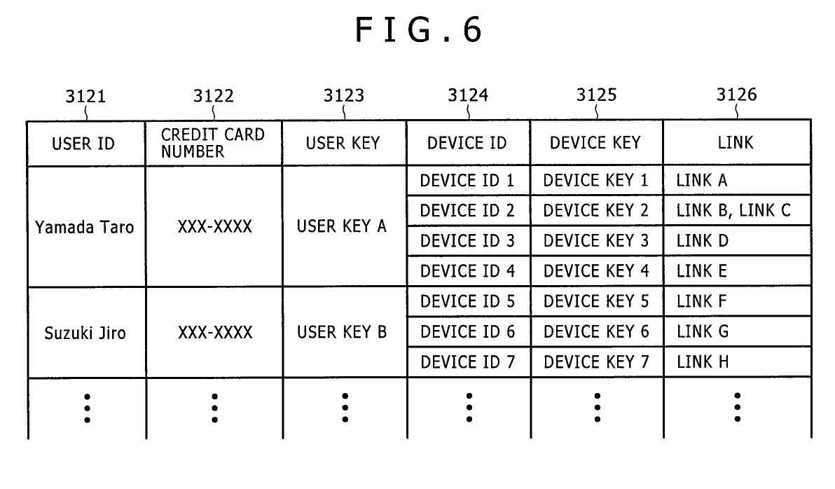

User information stored in the user information storage section 312 is described with reference to FIG. 6. As seen in FIG. 6, information of a user ID 3121, a credit card number 3122, a user key 3123, a device ID 3124, a device key 3125, a link 3126 and so forth is stored in the user information storage section 312.

The user ID 3121 and the credit card number 3122 are user account information of the user who receives the content providing service and the copyright management service provided to the user and is identification information with which the user can be specified uniquely. The user key 3123 is key information allocated to a user ID in the user ID 3121.

The device ID 3124 retains an ID of user apparatus linked to and owned by a user. The device key 3125 retains numbers identified uniquely in the content providing system 100. Each of the numbers may be an identification number set to each user apparatus upon shipment from a factory or the like or an identification number set by the registration section 306 of the copyright management server 20a.

The device key 3125 retains key information allocated to the user apparatus. Also the device key 3125 may retain a device key set to each user apparatus in advance or key information allocated by the registration section 306.

The link 3126 retains link information set for each user apparatus. For example, if the user apparatus 1 is link to “Yamada Taro”, then the “link A” includes information of the direction of the association of the device ID and the user ID and information obtained by encrypting the user key A (private key) with the device key 1 (public key). The information of each of the links in the link 3126 may be transmitted to the corresponding user apparatus so that it may be stored into the storage section of the user apparatus or may be acquired by the corresponding user apparatus through accessing of the user apparatus to the server. The stored information of the user information storage section 312 is such as described hereinabove.

Referring back to FIG. 5, the link issuance section 308 issues a license including a content key to a user who purchases a content. Thereupon, the license issuance section 310 encrypts the content key included in the license with the private key of the user so that the content key can be distributed in safety to the user. The license may further include utilization conditions and so forth of the content. The content key and the utilization conditions of the content may be provided otherwise from the content providing server 20b.

The license issued by the license issuance section 310 is transmitted to the user apparatus 10 through the sender section 304. Further, the license may be stored into the user information storage section 312.

The license includes a content ID for identification of the content and so forth. The user may acquire the license from the copyright management server 20a after it purchases the content or may alternatively acquire the license in advance before it purchases the content and then purchase the content.

Further, the user information storage section 312 in which content keys are stored and the license issuance section 310 may be provided alternatively in the content providing server 20b. In this instance, the content providing server 20b may acquire information of a user key for encryption of a content key and so forth from the copyright management server 20a and encrypt the content key to produce a license. The license produced by the content providing server 20b may be transmitted to the user apparatus owned by the user together with the content.

The sender section 304 is a communication interface formed from, for example, a communication line, a communication circuit, a communication device and so forth. The sender section 304 has a function of transmitting node information issued when a registration process is performed by the registration section 306, link information issued by the link issuance section 308 and a license issued by the license issuance section 310 to the user apparatus 10 through the network.

Content keys are stored in the content key storage section 314. The content key storage section 314 may receive and store a content key produced by the content providing server 20b or may store a content key produced by the copyright management server 20a. For example, the copyright management server 20a may produce and transmit a content key to a user apparatus and further transmit the content key to the content providing server 20b. The content providing server 20b receiving the content key may encrypt a content purchased by the user with the content key and transmit the encrypted content to the user apparatus 10.

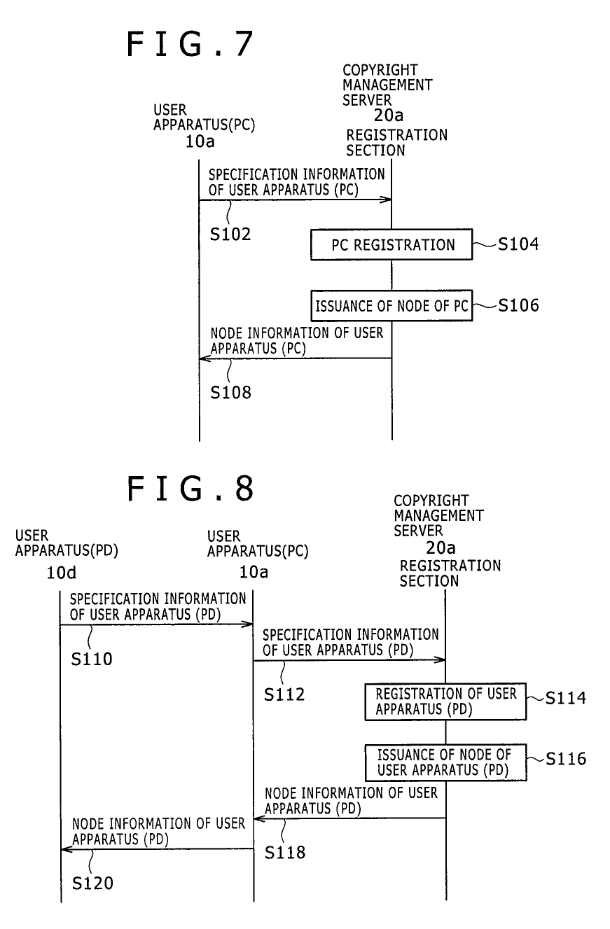

The functional configuration of the copyright management server 20a is described above. Now, a content providing method by the link system which utilizes the content providing system 100 is described. FIGS. 7 to 11 illustrate basic flows of processes of the content providing method by the link system. A user apparatus (PC) 10 and the copyright management server 20a included in the content providing system 100 are connected to each other for communication in safety therebetween through the network 30.

<5. User Apparatus and User Registration Method>

FIG. 7 illustrates a registration method of the user apparatus (PC) 10a connected to the network from among the user apparatus. First, specification information of the user apparatus (PC) 10a is transmitted to the copyright management server 20a (step S102). The specification information of the user apparatus here is information which can specify the user apparatus such as an apparatus type, a model, a version and so forth of the user apparatus. The specification information of the user apparatus may be transmitted from the user apparatus (PC) 10a in response to a user input, or where specification information is set to the user apparatus (PC) 10a in advance, it may be transmitted to the copyright management server 20a after a communication connection between the user apparatus (PC) 10a and the copyright management server 20a is established.

The copyright management server 20a receiving the specification information of the user apparatus (PC) 10a at step S102 stores the specification information into the user information storage section 312 of the copyright management server 20a (step S104). Further, based on the received specification information of the user apparatus (PC) 10a, the copyright management server 20a applies a device ID with which the user apparatus (PC) 10a can be specified uniquely to the user apparatus (PC) 10a. Furthermore, the copyright management server 20a issues a device key for the user apparatus (PC) 10a. The device ID and the device key issued in this manner are stored in an associated relationship with the specification information of the user apparatus (PC) 10a into the user information storage section 312. The device key is issued for each apparatus and may include a public key and a private key paired with each other to be used in public key cryptography or may be a common key used in private key cryptography.

After registration of the user apparatus (PC) 10a is performed at step S104, the copyright management server 20a issues a node including the device ID and the device key issued at step S104 (step S106). The node issued at step S106 is information with which the copyright management server 20a can uniquely specify the user apparatus (PC) 10a and at least includes the device ID. However, the node may include the device key or the specification information of the user apparatus (PC) 10a or the like. The node issued at step S106 is transmitted to the user apparatus (PC) 10a (step S108).

The user apparatus (PC) 10a stores the node information transmitted to the copyright management server 20a into the memory provided therein.

The method of registering the user apparatus (PC) 10a connected to the network is such as described above. Now, a method of registering a user apparatus which is not connected to the network such as, for example, the PD 10d is described with reference to FIG. 8.

FIG. 8 illustrates a registration method of the user apparatus (PD) 10d which is not connected to the network. First, specification information of the user apparatus (PD) 10d is provided to the user apparatus (PC) 10a (step S110). For example, an apparatus type, a model, a version and so forth of the user apparatus (PD) 10d may be transmitted to the user apparatus (PC) 10a after the user apparatus (PD) 10d is connected to the user apparatus (PC) 10a, or the specification information of the user apparatus (PD) 10d may be transmitted to the user apparatus (PC) 10a in response to an input of the user.

The user apparatus (PC) 10a acquiring the specification information of the user apparatus (PD) 10d at step S10 transmits the specification information of the user apparatus (PD) 10d to the copyright management server 20a (step S112). The copyright management server 20a receiving the specification information of the user apparatus (PD) 10d at step S112 registers the user apparatus (PD) 10d (step S114). In particular, at step S114, the copyright management server 20a stores the specification information of the user apparatus (PD) 10d into the user information storage section 312, issues a device ID and a device key for the user apparatus (PD) 10d and stores the device ID and the device key in an associated relationship with the specification information of the user apparatus (PD) 10d into the user information storage section 312.

After the registration process of the user apparatus (PD) 10d is performed at step S114, the copyright management server 20a issues a node of the user apparatus (PD) 10d (step S116). The node issued at step S116 includes the identification information of the user apparatus (PD) 10d with which the copyright management server 20a can uniquely specify the user apparatus (PD) 10d and the device key and so forth. The node of the user apparatus (PD) 10d issued at step S116 is transmitted to the user apparatus (PC) 10a (step S118).

The user apparatus (PC) 10a to which the node information of the user apparatus (PD) 10d is transmitted from the copyright management server 20a at step S118 provides the node information of the user apparatus (PD) 10d to the user apparatus (PD) 10d (step S120). The user apparatus (PD) 10d to which the node information is provided at step S120 stores the node information into the storage section such as a memory. The node information of the user apparatus (PD) 10d may otherwise be stored into the memory of the user apparatus (PC) 10a.

In order for the user apparatus (PD) 10d to acquire a content and a content key for decrypting the content, it must be connected to the user apparatus (PC) 10a. Accordingly, if the user apparatus (PC) 10a has the information of the user apparatus (PD) 10d stored therein, then the user apparatus (PC) 10a can decide whether or not the content received can be reproduced by the user apparatus (PD) 10d.

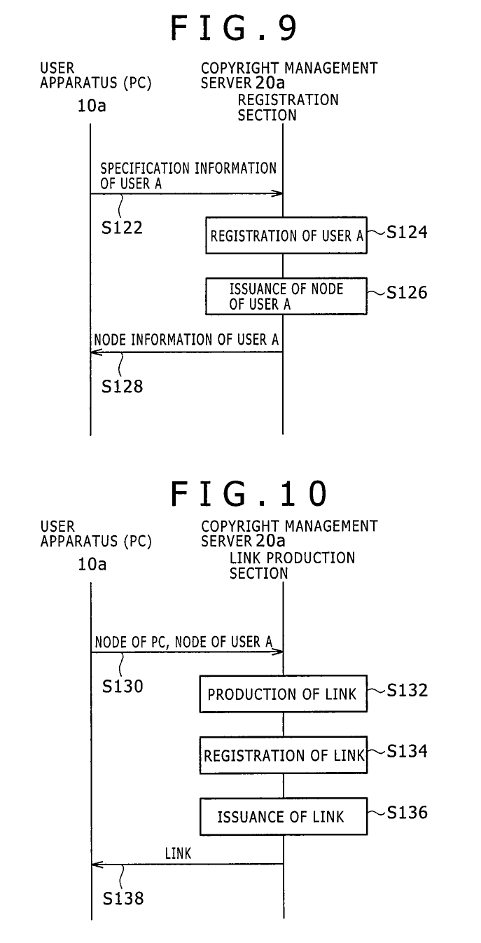

The registration method of the user apparatus (PD) 10d which is not connected to the network is such as described above. Now, a registration method of a user who uses a user apparatus is described with reference to FIG. 9.

FIG. 9 illustrates a registration method of a user. The registration method of the user A is performed through the user apparatus (PC) 10a connected to the network. First, specification information of the user A is transmitted to the copyright management server 20a (step S122). Here, the specification information of the user A includes a user ID of the user A and a credit card number or the like owned by the user A. The user ID is identification information with which the user can be specified uniquely by the copyright management server 20a and may be identification information designated by the user A or provided by the copyright management server 20a.

The copyright management server 20a to which the specification information of the user A is transmitted at step S122 performs a registration process of the user A (step S124). In particular, at step S124, the copyright management server 20a stores the user ID, credit number and so forth of the user A into the user information storage section 312. Further, the copyright management server 20a issues a user key for the user A and stores the user key in an associated relationship with the user ID and so forth into the user information storage section 312.

Then, the copyright management server 20a issues a node including the user ID and the user key stored in the user information storage section 312 (step S126). The copyright management server 20a transmits the node information issued at step S126 to the user apparatus (PC) 10a.

A user who owns a user apparatus registers the user apparatus owned thereby into the copyright management server 20a through a network in such a manner as described above. Further, user registration of a user who utilizes the content providing service or the copyright management service is performed. Consequently, the copyright management server 20a which provides the copyright management service can store and manage information of users who desire to utilize the copyright management service and information of user apparatus owned by the users into and in the user information storage section 312. Further, the copyright management server 20a can store and manage also key information issued to the users and the user apparatus in an associated relationship with the users or the user apparatus into and in the user information storage section 312.

The copyright management server 20a can acquire the user ID of the user A through a user apparatus connected to the network to know the user apparatus owned by the user and key information of the user. For example, in order to distribute a content key used to encrypt a content in safety to a user, the copyright management server 20a may encrypt the content key further with the user key of the user A. The copyright management server 20a acquires, based on the acquired user ID of the user A, the cryptographic key of the user A stored in the user information storage section 312 and encrypts the content key with the user key of the user A. Since the content key encrypted with the public key of the user A cannot be decrypted without using the private key of the user A, the copyright management server 20a can transmit the content in safety to the user. Further, since only the user A who purchases the content can decrypt the content key, also it is possible to restrict the user who can decrypt the content key.

However, even if the content key can be decrypted with the cryptographic key of the user A, if the content cannot be reproduced on the user apparatus owned by the user A, then the user A cannot enjoy the content. In the present content providing system, since each user apparatus is associated with a user, a content purchased by the user A can be reproduced on the user apparatus. Now, association between the user A and the user apparatus is described.

<6. Association between the User A and the User Apparatus>

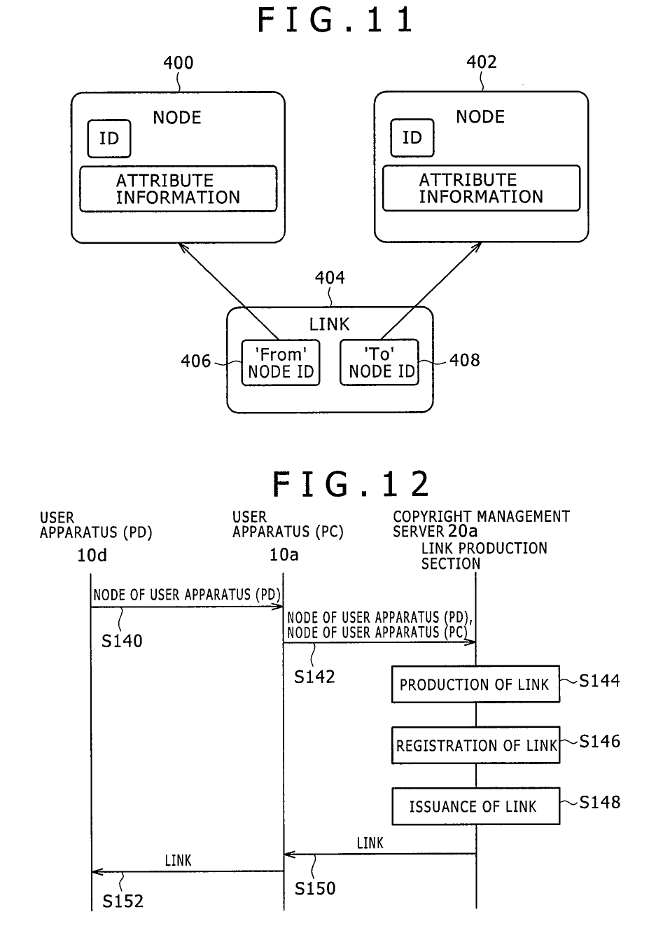

FIGS. 10 and 11 illustrate association between the user A and the user apparatus. First, association between the user apparatus (PC) 10a connected to the network and the user A is described. In order to associate the user apparatus (PC) 10a and the user A with each other, the node of the user apparatus (PC) 10a and the node of the user A issued by the registration process described hereinabove are transmitted to the copyright management server 20a (step S130).

The copyright management server 20a acquiring the node information of the user apparatus (PC) 10a and the node information of the user A at step S130 produces a link for associating the user apparatus (PC) 10a and the user A with each other (step S132). The link produced at step S132 includes, for example, the node information of the user apparatus (PC) 10a, the node information of the user A and the direction of the association. The node information included in the link information may be any information with which the user apparatus or the user can be identified uniquely and may be the device ID of the user apparatus or the user ID of the user. For example, the direction of the association is information representing which node is associated with which node. The direction of the association is information representative of the direction from the user apparatus (PC) 10a which serves as a source of the link to the user A which serves as a destination of the link.

Here, the link produced at step S132 is described in detail with reference to FIG. 11. As described hereinabove, the user apparatus (PC) 10a and the user A are managed as a node from the device ID or the user ID by the copyright management server 20a. If such node information 400 or 402 is transmitted to the copyright management server 20a, then the copyright management server 20a sets information of “From” 406 and “To” 408 included in a link 404. When the user apparatus (PC) 10a is to be associated with the user A, the node ID of the user apparatus (PC) 10a which serves as a source of the link is set to the “From” 406, and the node ID of the user A is set to the “To” 408. The node ID here is identification information for identification of a node of the user apparatus (PC) 10a or the user A and may be the device ID of the user apparatus (PC) 10a or the user ID of the user A.

The link 404 may further include key information obtained by encrypting private information of the user A which serves as a destination of the link with the public key of the user apparatus (PC) 10a which serves as a source of the link. The private information of the user A is information which can originally be known only to the user A and may be information of the private key of the user A or the like.

Referring back to FIG. 10, the link information produced at step S132 is stored in an associated relationship with the device ID of the user apparatus (PC) 10a of the destination of the link into the user information storage section 312 (step S134). Consequently, the copyright management server 20a can manage with which user each of the user apparatus stored in the user information storage section 312 is associated. Then, the copyright management server 20a issues link information including the device ID of the user apparatus, the user ID of the user and the direction of the association (step S136) and transmits the link information to the user apparatus (PC) 10a (step S138). As described hereinabove, the link information transmitted to the user apparatus (PC) 10a may include key information obtained by encrypting the private information of the user A with the public key of the user apparatus (PC) 10a.

The user apparatus (PC) 10a receiving the link information at step S138 can know, from the received link information, with which user the user apparatus (PC) 10a is associated. Further, where the user apparatus (PC) 10a is associated with the user A, the user apparatus (PC) 10a can know the private information of the user A using the key information included in the link. For example, if the user A registers the user A itself into the content providing service and purchases a content, then the content is encrypted and transmitted to the user A. The content key used to encrypt the content is encrypted with the private key of the user A and transmitted to the user apparatus (PC) 10a owned by the user A. At this time, if the user apparatus (PC) 10a is associated with the user A, then the user apparatus (PC) 10a can acquire the private information of the user A included in the link information received from the copyright management server 20a and decrypt the encrypted content key using the private information.

Association between the user apparatus (PC) 10a connected to the network and the user A is such as described above. Now, association between the user apparatus (PD) 10d which is not connected to the network and the user apparatus (PC) 10a is described with reference to FIG. 12.

First, the user apparatus (PC) 10a acquires node information of the user apparatus (PD) 10d connected to the user apparatus (PC) 10a (step S140). The user apparatus (PC) 10a acquiring the node information of the user apparatus (PD) 10d at step S140 transmits the node information of the user apparatus (PD) 10d and the node information of the user apparatus (PC) 10a itself to the copyright management server 20a (step S142). At step S142, the user apparatus (PC) 10a may transmit the direction of association together with the node information of the user apparatus (PD) 10d and the user apparatus (PC) 10a.

The copyright management server 20a receiving the nodes of the user apparatus and the information of the direction of association at step S142 produces a link based on the received information (step S144). As described above, the link information produced at step S144 includes the node information of the user apparatus (PD) 10d, the node information of the user apparatus (PC) 10a, and the information of the direction of association.

The link information produced at step S144 is recorded in an associated relationship with the device ID of the user apparatus (PD) 10d into the user information storage section 312 (step S146). Then, the copyright management server 20a issues node information which includes the node information of the user apparatus (PD) 10d, the node information of the user apparatus (PC) 10a and the information of the direction of association (step S148). Then, the copyright management server 20a transmits the link information to the user apparatus (PC) 10a (step S150).

The user apparatus (PC) 10a receiving the link information from the copyright management server 20a at step S150 provides the link information to the user apparatus (PD) 10d (step S152). As described above, the link information includes information representing that the user apparatus (PD) 10d is associated with the user apparatus (PC) 10a. In other words, the node information of the user apparatus (PD) 10d is set to the “From” 406 of the link 404 and the node information of the user apparatus (PC) 10a is set to the “To” 408 of the link 404.

The link further includes key information obtained by encrypting the private key of the user apparatus (PC) 10a stored in the user information storage section 312 with the public key of the user apparatus (PD) 10d or the like. By acquiring the link information, the user apparatus (PD) 10d can acquire the information of the private key of the user apparatus (PC) 10a.

Further, when a link is issued at step S148, the link information of the user apparatus (PC) 10a which is a link destination of the user apparatus (PD) 10d may be transmitted. Where the user apparatus (PC) 10a is associated with the user A, also the link information which associates the user apparatus (PC) 10a and the user A with each other is transmitted to the user apparatus (PD) 10d. Consequently, after the user apparatus (PD) 10d acquires the information of the private key of the user apparatus (PC) 10a, it can acquire also the information of the private key of the user A using the information of the private key of the user apparatus (PC) 10a.

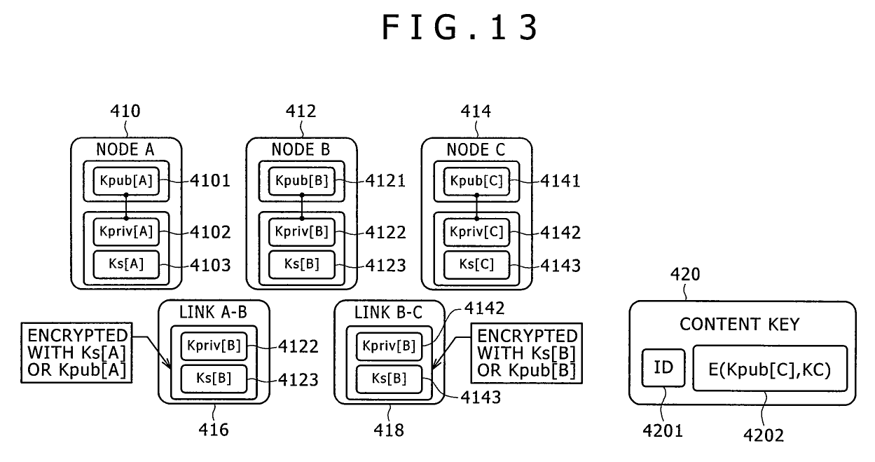

Now, key information included in a link is described with reference to FIG. 13. FIG. 13 illustrates key information included in a link.

As seen in FIG. 13, it is assumed that three nodes of a node A, another node B and a further node C are stored in the user information storage section 312 of the copyright management server 20a. As described hereinabove, node information including identification information, key information and so forth is allocated to each user apparatus or each user. A private key, a public key, a common key and so forth are issued to each of the users and the user apparatus.

The information included in the nodes is described. The node A 410 includes a public key (Kpub[A]) 4101, a private key (Kpriv[A]) 4102 and a common key (Ks[A]) 4103. Where the public key cryptography method is used to perform encryption, encryption is performed using the public key 4101 and decryption is performed using the private key 4102 paired with the public key 4101. On the other hand, where the common key cryptography method is used, the same key is used for both of encryption and decryption, and the common key 4103 is used to perform encryption whereas the common key 4103 is used to perform decryption.

The public key cryptography method is a method wherein the key for encryption is laid open while the key for decryption is kept secret. For example, the public key 4101 of the node A is stored in a public key file on the network and can be referred to freely by anybody. On the other hand, the private key 4102 paired with the public key 4101 is managed secretly such that it cannot be acquired by any other than the copyright management server 20a and the user A.

On the other hand, the common key cryptography method described hereinabove is a method wherein the transmission side and the reception side share and keep a common key secret. For example, the common key 4103 of the node A must be managed secret so that it may not be acquired by any other than the copyright management server 20a and the node A.

Similarly, the node B 412 includes a public key (Kpub[B]) 4121, a private key (Kpriv[B]) 4122 and a common key (Ks[B]) 4123 of the node B. The node C 414 includes a public key (Kpub[C]) 4141, a private key 4142 (Kpriv[C]) 4141 and a common key (Ks[C]) 4143 of the node C.

As seen in FIG. 13, in order to associate the node A with the node B, a link 416 is issued. The link 416 includes the node ID of the node A, the node ID of the node B and the information of the direction of association between the node A and the node B. As described hereinabove, where the node A is associated with the node B, the link source is the node A and the link destination is the node B. Further, the link 416 includes key information obtained by encrypting the private key 4122 which is the private information of the node B and the common key 4123 with the public key 4101 or the common key 4103 of the node A.

The node A acquiring the link 416 can know with which node the node A itself is associated and acquire the private information of the link destination associated therewith. Since the private information of the node B included in the link 416 is encrypted with the public key 4101 or the common key 4103, it cannot be decrypted without using the private key 4102 or the common key 4103 of the node A which is managed secretly by the node A itself. In other words, the key information included in the link 416 cannot be decrypted even if anyone other than the node A acquires the same.

Similarly, the link 418 includes the node ID of the node B, the node ID of the node C and the information of the direction of association between the node B and the node C. The information of the direction included in the link 418 is the direction from the node B to the node C, and the link source is the node B while the link destination is the node C. Further, the link 418 includes information obtained by encrypting the private information of the node C with the public key 4121 or the common key 4123 of the node B. The node B can acquire the private key 4142 or the common key 4143 of the node C from the link 418.

For example, it is assumed that the node C is information allocated to the user who purchases a content. The user purchasing the content would transmit the node C to the copyright management server 20a. The copyright management server 20a receiving the node C which is a node of the user encrypts a content key (KC) used to encrypt the content purchased by the user with the public key (Kpub[C]) of the node C which is the public key of the user. The content key 420 encrypted with the public key 4141 of the node C is transmitted to the user apparatus (PC) 10a owned by the user.

If the node B is applied to the user apparatus (PC) 10a owned by the user, then if the content key encrypted with the public key of the node C cannot be decrypted with the private key of the node B, then the content encrypted with the content key cannot be reproduced on the user apparatus (PC) 10a. However, if the link 418 is issued to the node B, then the node B can acquire the private information of the node C based on the information of the link 418. If the user apparatus (PC) 10a to which the node B is allocated can acquire the private information of the user to which the node C is allocated, then the user apparatus (PC) 10a can decrypt the content key 420 using the private key of the user included in the private information and then decrypt the encrypted content using the content key 420.

If the node A is applied to the user apparatus (PD) 10d to which the user apparatus (PC) 10a is connected, then the user apparatus (PD) 10d can decrypt the encrypted private information of the node B using the key of itself. Further, the user apparatus (PD) 10d can decrypt the private information of the node C included in the link 418 with the private key of the node B included in the link 416. The user apparatus (PD) 10d to which the node A is allocated and which acquires the private key of the node C can decrypt the encrypted content key 420 with the public key of the node C and then decrypt the encrypted content with the content key 420.

In FIG. 13, the node A is associated with the node B, and the node B is associated with the node C. However, the node A may otherwise be associated directly with the node C. In this instance, link information to be issued to the node A includes the node ID of the node A set as the link source and the node ID of the node C as the link destination. The link information further includes key information obtained by encrypting the private information of the node C with the public key of the node A.

In order for a user who purchases a content to reproduce the content on a user apparatus owned by the user, it is necessary for the user apparatus to acquire information of the user key used to encrypt the content key. Each user apparatus acquires a user key used to encrypt the content key based on link information issued to the user itself and decrypts the content key with the user key.

Where a content key used to encrypt a content is encrypted with the public key of a user and transmitted to a user apparatus owned by the user in this manner, the user apparatus associated with the user can decrypt and reproduce the encrypted content. Even if the content key for encrypting the content is not encrypted with a key unique to each user apparatus to be used for reproduction, it is possible to acquire key information used to encrypt the content key based on the link information and decrypt the content key with the key information. The user apparatus can know with which user the user apparatus itself is associated. In other words, the user apparatus can know, from the link information, of which user the user apparatus can acquire the private information.

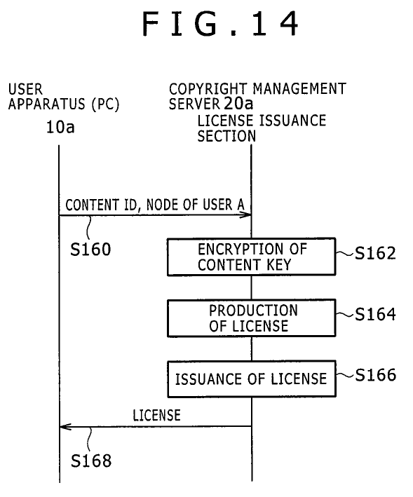

The key information included in the links is such as described above. Now, a license issued by the copyright management server 20a is described with reference to FIG. 14.

<7. License>

FIG. 14 illustrates issuance of a license by the copyright management server 20a. A license issued by the copyright management server 20a includes information of a content key for decrypting a content purchased by a user and so forth which is necessary to reproduce the content. The content key included in the license is further encrypted with a user key or the like, and a user apparatus or the like which acquires the license can know, from various information included in the license, with which user key the content key is encrypted. If the user apparatus or the like acquiring the license can decrypt the content key based on the link information and so forth described above, then it can reproduce the encrypted content using the content key.

The user apparatus (PC) 10a transmits the content ID for uniquely identifying a content and the node information of the user A to the copyright management server 20a in order to acquire a license necessary to reproduce the content (step S160). As described hereinabove, if user apparatus owned by the user A are associated with the user A, then a license issued to the user A can be used also by the user apparatus associated with the user A.

The copyright management server 20a receiving the content ID and the node information of the user A at step S1160 encrypts the content key used to encrypt the content with the public key of the user A (step S162). Then, the copyright management server 20a produces a license including the content key encrypted at step S162 (step S164).

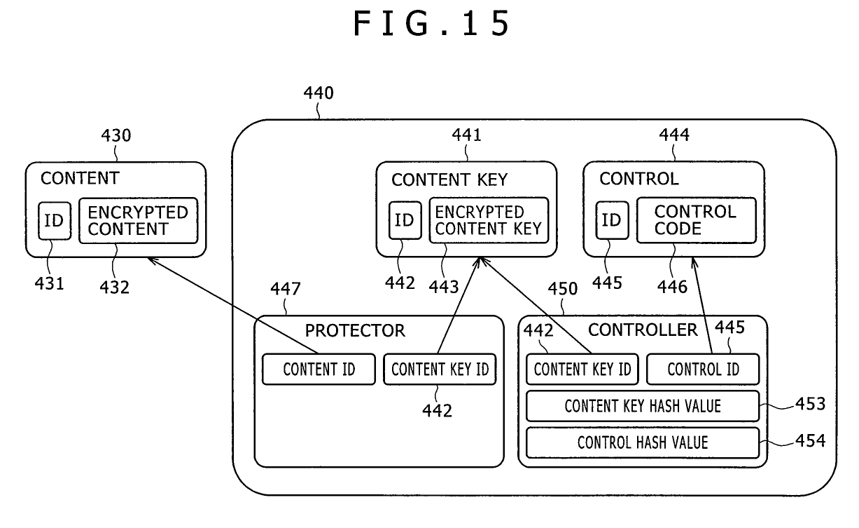

The license produced at step S164 is described with reference to FIG. 15. As seen in FIG. 15, the license 440 includes a content key 441, a control 444, a protector 447, a controller 450 and so forth. The content 430 is encrypted with the content key included in the license 440, and the encrypted content 432 is transmitted from the content providing server 20b.

The content key 441 included in the license 440 is in a form encrypted with a key included in the node information transmitted from the user apparatus (PC) 10a. For example, if the node information of the user A is transmitted from the user apparatus (PC) 10a, then the content key is encrypted with the public key of the user A. The protector 447 includes a content ID which is identification information of a content, and a content key ID which is identification information of a content key. It can be discriminated from the information included in the protector 447 which content should be reproduced using the license 440.

The control 444 includes a control code 446 which is a utilization condition or the like of a content. The control code 446 includes a reproduction term of a content purchased by the user and so forth, and the user would utilize the content within a range of the utilization condition described in the control code 446. The control code 446 may additionally include information representing to which node the license 440 is issued.

A user apparatus which acquires the license 440 refers to the control 444 to decide to which node the license 440 is issued. If a result of the decision indicates that the license 440 is issued to the user associated with the user apparatus, then the user apparatus can utilize the license to reproduce the content.

The controller 450 is information which associates the content key 441 and the control 444 with each other and includes identification information of the content key 441 and identification information of the control 444. Further, in order to decide falsification of the content key 441 and the control 444, the controller 450 may further include a hash value 453 of the content key 441 and a hash value 454 of the control 444. For example, when the license 440 is transmitted from the copyright management server 20a to a user apparatus or the like, if the content key 441 included in the license 440 is falsified, then a hash value determined from the content key 441 and a hash value included in the controller 450 become different from each other. Therefore, it can be decided whether or not the content key 441 is falsified. Also falsification of the control 444 can be decided from the hash value 454, and when the license 440 is transmitted, rewriting of utilization conditions of a content and so forth can be found out. The description of the license is completed therewith.

Referring back to FIG. 14, the license produced at step S164 is issued to the user apparatus (PC) 10a (step S116) and transmitted to the user apparatus (PC) 10a (step S168).

The user apparatus (PC) 10a receiving the license at step S168 decodes the content key encrypted with the user key of the user who owns the user apparatus (PC) 10a using the key information included in the link. Then, the user apparatus (PC) 10a can decrypt and reproduce the content encrypted with the content key using the decrypted content key.

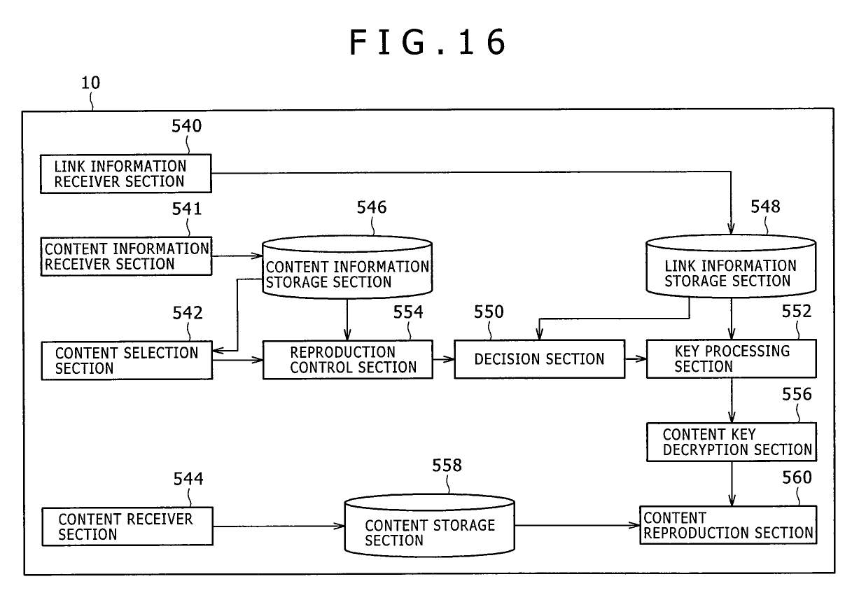

Issuance of a license is performed in such a manner as described above. Now, a functional configuration of the user apparatus 10 which reproduces a content whose copyright is protected by the link system is described with reference to FIG. 16. In the following description, a user apparatus 10 is referred to as content reproduction apparatus 10.

<8. Functional Configuration of the Content Reproduction Apparatus>

The content reproduction apparatus 10 includes a link information receiver section 540, a content information receiver section 541, a content selection section 542, a content receiver section 544, a content information storage section 546, and a link information storage section 548. The content reproduction apparatus 10 further includes a decision section 550, a key processing section 552, a reproduction control section 554, a content key decryption section 556, a content storage section 558, a content reproduction section 560 and so forth.

The link information receiver section 540 receives link information from the copyright management server 20a. As described hereinabove, the link information includes a pair of pieces of identification information one of which represents a link source and the other of which represents a link destination. The identification information is identification information (user ID) with which the copyright management server 20a uniquely identifies the user or identification information (device ID) with which the copyright management server 20a uniquely identifies the content reproduction apparatus. The link information further includes information obtained by encrypting a key (user key or device key) unique to a user or a content reproduction apparatus specified by identification information set to the link destination with a key unique to a user or a content reproduction apparatus specified by identification information set to the link source.

The link information storage section 548 stores link information received by the link information receiver section 540. The link information storage section 548 stores the link information to establish an associated relationship between the device ID of a content reproduction apparatus 10 (hereinafter referred to as self apparatus) to which the link information storage section 548 belongs and the user ID of the user who utilizes the self apparatus. More particularly, the link information storage section 548 produces a route whose starting point is the self apparatus and whose arriving point is the user in accordance with the link information stored therein to implement an associated relationship between the self apparatus and the user who uses the self apparatus. Where the route is formed, the content reproduction apparatus 10 can trace the link information to decrypt the user key of the user associated with the self apparatus with the device key unique to the self apparatus.

The content information receiver section 541 receives content information from the copyright management server 20a. In particular, the content information receiver section 541 receives content information from the copyright management server 20a through a communication network. The content information includes a content ID, meta information of the content, an encrypted content key, a user ID and utilization restriction information. The content information receiver section 541 stores the received content information into the content information storage section 546.

The content information storage section 546 stores content information. The content information storage section 546 is formed from a RAM or a HDD.

The content selection section 542 selects content information stored in the content information storage section 546. In particular, the content selection section 542 includes a display section such as a display unit for displaying meta information of contents included in the content information stored in the content information storage section 546, and an inputting section such as a mouse or a keyboard for being operated by the user to select a desired piece of the meta information. The content selection section 542 supplies the content ID of a content coordinated with the meta information selected by the user to the reproduction control section 554.

Further, the content selection section 542 selects one, two or more contents from within a content table transmitted thereto from a content transfer apparatus. The content table transferred from the content transfer apparatus is information from which the substance of the contents such as the title of the contents can be discriminated, and one, two or more content titles are selected by inputting of the user.

The reproduction control section 554 restricts reproduction of a content. The reproduction control section 554 acquires content information in which a content ID acquired from the content selection section 542 is included from the content information storage section 546. Then, the reproduction control section 554 decides, based on utilization restriction information included in the acquired content information, whether or not reproduction of the content selected by the content selection section 542 is permitted. In particular, for example, the reproduction control section 554 stores the number of times of reproduction of each content and compares a reproduction permitting time number included in the utilization restriction information with a reproduction time number stored therein to decide whether or not reproduction of the content may be permitted. Or, the reproduction control section 554 compares reproduction permission date and hour included in the utilization restriction information with the date and hour at present to decide whether or not reproduction of the content may be permitted.

The decision section 550 decides based on the user ID included in the content information and the user ID coordinated with the self apparatus in the link information storage section 548 whether or not it should be performed for the content key decryption section 556 to perform decryption of the content key. In particular, the decision section 550 acquires content information from the reproduction control section 554. Then, the decision section 550 compares the user ID included in the acquired content information with the user ID coordinated with the self apparatus in the link information storage section 548, and if the two user IDs correspond to each other, then the decision section 550 permits a decryption process of the content key by the content key decryption section 556. When a decryption process is to be permitted, the decision section 550 causes the key processing section 552 to start its processing to continue a succeeding process of the content reproduction apparatus 10. That the two user IDs correspond to each other is that one of the user ID can be led out from the other user ID in accordance with a predetermined rule and includes a case wherein the two user IDs coincide with each other.

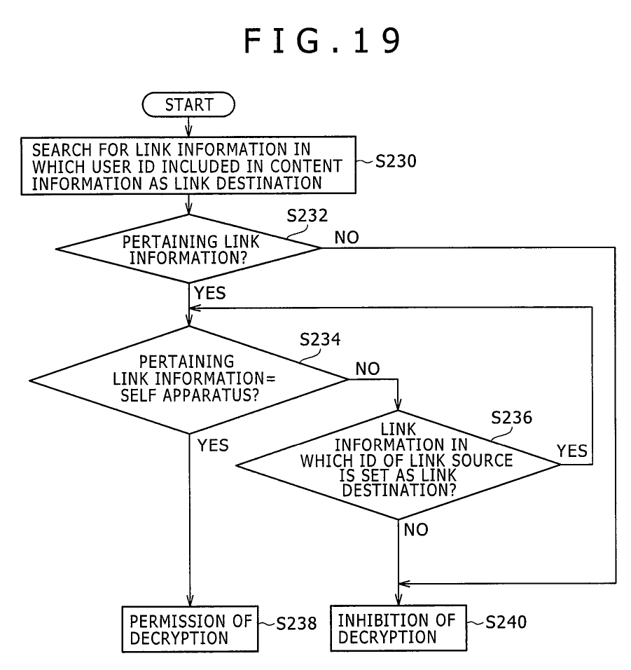

A particular example of the processing executed by the decision section 550 is described with reference to FIG. 19. First, the decision section 550 checks whether or not the user ID included in the acquired content information is stored in the link information storage section 548. If the user ID is stored in the link information storage section 548, then the decision section 550 checks based on the link information whether or not a route whose start point is the self apparatus and whose arriving point is the user ID is produced in the link information storage section 548. In short, the decision section 550 searches the link information storage section 548 for link information (for example, a link A) with which the user ID included in the content information is set as a link destination (step S230).

If the pertaining link information is found (step S232), then the decision section 550 decides whether or not the identification information set as the link source of the link A is the device ID of the self apparatus (step S234). If the link source of the link A is the device ID of the self apparatus, then the decision section 550 decides that a route whose starting point is the self apparatus and whose arriving point is the user ID is produced and permits a decryption process of the content key by the content key decryption section 556 (step S238).

If the link source of the link A is not the device ID of the self apparatus at step S234, then the decision section 550 searches for different link information (for example, the link B) in which the identification information of the link source of the link A is set as a link destination (step S236). If the pertaining link information is not found, then the decision section 550 decides that a route whose starting point is the self apparatus and whose arriving point is the user ID is not produced as yet and does not permit a decryption process of the content key by the content key decryption section 556 (step S240). On the other hand, if the pertaining link information is found at step S206, then the decision section 550 decides whether or not the identification information set as the link source of the link B is the device ID of the self apparatus (step S234).

If the processes described above are repeated to trace the link information until link information by which the device ID of the self apparatus is set as the link source is stored in the link information storage section 548, then the decision section 550 permits a decryption process of the content key by the content key decryption section 556.

When the decision section 550 permits a decryption process of the content key, it provides the link information specified in the processes described above for producing the route from the self apparatus to the user ID (for example, link A, link B and link C) and the content information acquired from the content information storage section 546 to the key processing section 552.

The key processing section 552 decrypts the user key of the user coordinated with the self apparatus based on the link information stored in the link information storage section 548. In particular, the key processing section 552 acquires the link information from the decision section 550 and first decrypts encrypted information (key) included in the link information (for example, link C) whose link source is the self apparatus with the device key unique to the self apparatus. Then, the key processing section 552 decrypts encrypted information (key) included in link information (for example, link B) wherein the identification information set as the link destination of the link C is set as the link source using the key decrypted immediately before then. The key processing section 552 repeats the process just described to decrypt the encrypted information (that is, user key encrypted with the key of the link source of the link A) included in the link information (for example, link A) which sets the user ID as the link destination. Thereafter, the key processing section 552 provides the decrypted user key and the content information acquired from the decision section 550 to the content key decryption section 556.

The content key decryption section 556 acquires the content information and the user key from the key processing section 552 and decrypts the content key included in the acquired content information with the acquired user key. The content key decryption section 556 provides a content ID included in the content information and the decrypted content key to the content reproduction section 560.

The content reproduction section 560 acquires the content ID and the content key from the content key decryption section 556, acquires a content specified by the acquired content ID, decrypts the content with the content key and reproduces the content.

The reproduction control section 554 receives a content from the copyright management server 20a or another computer or the like and stores the received content into the content storage section 558.

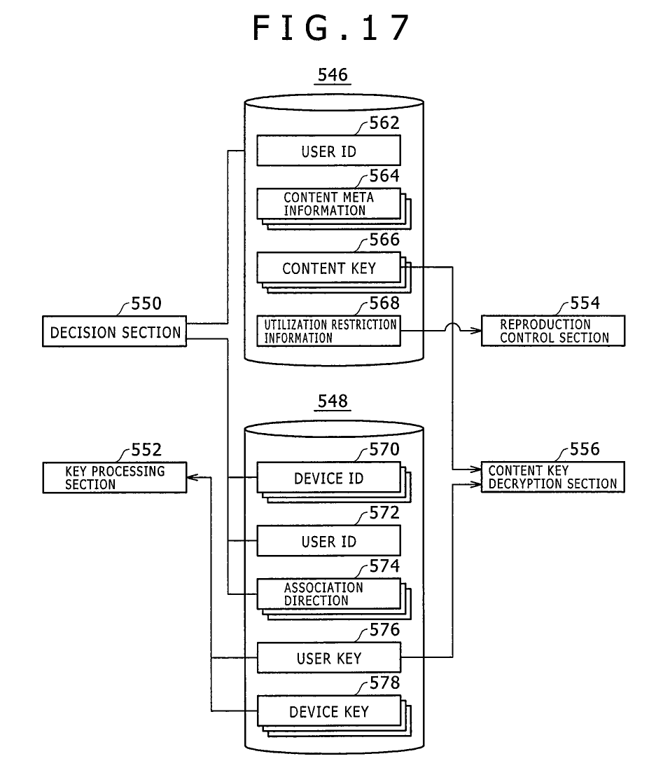

Now, which information is used by the processing sections relating to reproduction of a content to perform various processes is described simply with reference to FIG. 17.

Information relating to reproduction of a content in the content reproduction apparatus 10 is stored in the content information storage section 546 and the link information storage section 548. The content information storage section 546 stores one or a plurality of sets of content information each including a user ID 562, at least one piece of content meta information 564, at least one content key 566, utilization restriction information 568 and a content ID (not shown).

The link information storage section 548 stores link information as described hereinabove. Particularly, however, at least one device ID 570, a user ID 572, an association direction 574, a user key 576 and at least one device key 578 are stored in an associated relationship with each other as link information. It is to be noted that the association direction 574 indicates a link source and a link destination included in each piece of the link information.

The decision section 550 performs the decision process described hereinabove using the user ID 562 stored in the content information storage section 546 and the device ID 570, user ID 572 and association direction 574 stored in the link information storage section 548.

The key processing section 552 performs a decryption process of a user key described hereinabove using the user key 576 stored in the link information storage section 548 and the device key 578.

The reproduction control section 554 performs a decision process of whether or not reproduction should be permitted using the utilization restriction information 568 stored in the content information storage section 546.

The content key decryption section 556 performs a decryption process of a content key described hereinabove using the content key 566 stored in the content information storage section 546 and the user key 576 stored in the link information storage section 548.

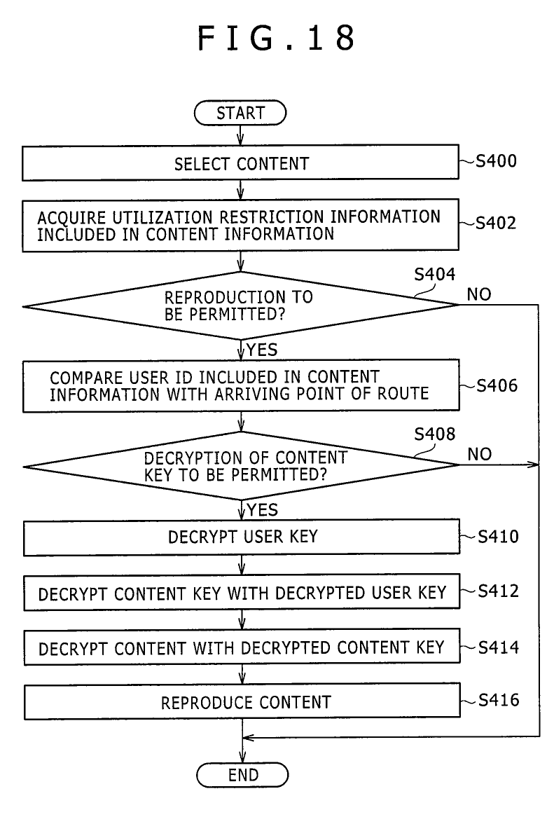

The functional configuration of the content reproduction apparatus 10 is such as described above. It is to be noted that, although all of the functions described above may be provided in one computer to form a content reproduction apparatus 10, the functions may be distributed to a plurality of computers which generally function as a single content reproduction apparatus 10. Now, a flow of a content reproduction process executed by a content reproduction apparatus 10 is described with reference to FIG. 18.

<9. Flow of the Content Reproduction Process>

The content reproduction apparatus 10 first selects a content to be reproduced (step S400). More particularly, the content reproduction apparatus 10 receives an inputting process by the user, and the content selection section 542 thereof designates a content ID of a content to be reproduced.

Then, the content reproduction apparatus 10 acquires utilization restriction information included in the content information (step S402). More particularly, the reproduction control section 554 acquires utilization restriction information associated with the content information designated at step S400 and including the content ID from the content information storage section 546.

Then, the content reproduction apparatus 10 decides whether or not reproduction of the content should be permitted (step S404). More particularly, the reproduction control section 554 decides based on the utilization restriction information acquired at step S402 whether or not reproduction of the content should be permitted. If a result of the decision is permission of the reproduction, then the processing advances to step S406. On the other hand, when reproduction should not be permitted, the content reproduction apparatus 10 ends the processing without performing reproduction of the content.

At step S406, the content reproduction apparatus 10 compares the user ID included in the content information and the arriving point of the route with each other. More particularly, the decision section 550 compares the user ID included in the content information specified at step S402 and the user ID associated with the self apparatus in the link information storage section 548 with each other.

Then, the content reproduction apparatus 10 decides whether or not decryption of the content key should be permitted (step S408). More particularly, if the two user IDs compared with each other at step S406 coincide with each other, then the decision section 550 permits decryption of the content key, and the processing advances to step S410. On the other hand, if the two user IDs do not coincide with each other, then the decision section 550 does not permit decryption of the content key and ends the processing without performing reproduction of the content.

Thereafter, the content reproduction apparatus 10 decrypts the user key (step S410). More particularly, the key processing section 552 uses the device key of the self apparatus to decrypt the encoded user key stored in the link information storage section 548. It is to be noted that the key processing section 552 uses the device key of a content reproduction apparatus 10 other than the self apparatus stored in the link information storage section 548 for decryption of the user key as occasion demands.

Then, the content reproduction apparatus 10 decrypts the content key (step S412). More particularly, the content key decryption section 556 decrypts the encoded content key included in the content information with the user key decrypted at step S410.

Then, the content reproduction apparatus 10 decrypts the content to be reproduced (step S414). More particularly, the content reproduction section 560 decrypts the encoded content with the content key decrypted at step S412.

Thereafter, the content reproduction apparatus 10 reproduces the content (step S416). More particularly, the content reproduction section 560 reproduces the content decrypted at step S414. The flow of the content reproduction process executed by the content reproduction apparatus 10 is such as described above.

<10. Concept of Key Management>

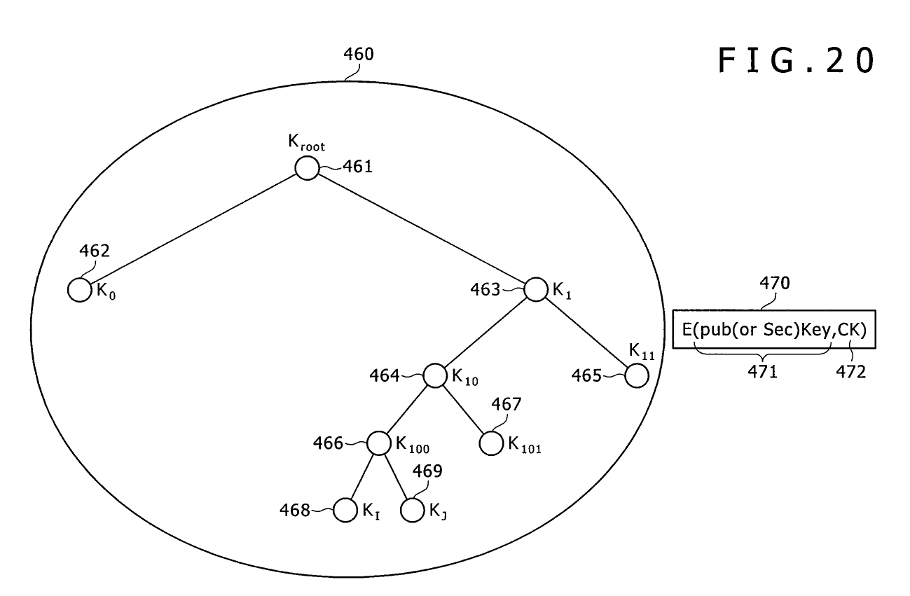

Now, a concept of a key bunch which a user apparatus has is described with reference to FIG. 20. Each user apparatus has a key bunch necessary to decrypt a content key and uses the key bunch to decrypt an encoded content key.

FIG. 20 illustrates a concept of key management in the present embodiment. Each user apparatus in the present embodiment adopts a concept of a tree structure as denoted by reference numeral 460. In particular, the tree structure 460 includes node keys allocated to the individual nodes and including a Kroot key 461 at the top of the tree structure and a K0 key 462, a K1 key 463, a K10 key 464, a K11 key 465, . . . . Further, at the lowermost stage, user keys possessed uniquely by user apparatus I and J are allocated like a KI key 468, another KJ key 469, . . . . Here, it is assumed that each node key is encrypted with a node key immediately below the same in the tree structure. For example, the K1 key 463 is encrypted with the K10 key 464 or the K11 key 465.

On the other hand, a pub (or Sec) Key 471 corresponds to the Kroot key 461. In particular, a content key 472 is encrypted with the Kroot key 461. While, in FIG. 13, a content key is encrypted with the public key of the node C, more particularly it is encrypted with the Kroot key 461.

Here, in order for the user apparatus I to acquire the content key 472 to be used to decrypt a content, a key bunch including the KI key, E(KI key, K100 key), E(K100 key, K10 key), E(K10 key, K1 key), E(K1 key, Kroot key), and E(pub (or Sec) Key, CK) is required. The key bunch is included in the content body.

In this manner, a user apparatus owned by a user can use a key bunch which it has to acquire the Kroot key 461 and decrypt the content key 472. As described hereinabove, in the present embodiment, a content protected under the copyright can be shared by different apparatus owned by a user in accordance with the link system.

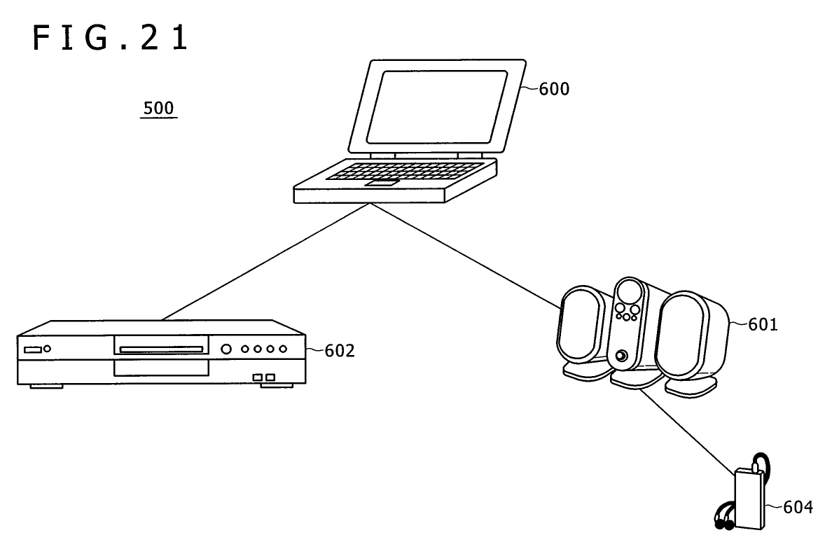

The copyright management method adopted by the information process distribution system 500 is such as described above. Now, a general configuration of the information process distribution system 500 is described with reference to FIG. 21.

<11. General Configuration of the Information Process Distribution System>

As described hereinabove, the information process distribution system 500 includes a management server 600, information processing apparatus 601 and 602, a user apparatus (PD) 604 and so forth. The management server 600 and the information processing apparatus 601 and 602 are connected to a network within a restricted range such as within a home and can transmit and receive information therebetween.

As a network which is utilized personally by an individual in a home or the like, a wire LAN (Local Area Network), a radio LAN, a W-PAN (Wireless-Personal Area Network) and so forth are available. For example, the W-PAN is a radio system which allows high speed transmission within a small range of a radius of approximately 10 m. Apparatus which can communicate by radio with each other within the range of the W-PAN can mutually acquire information of peripheral radio terminals so that the ratio terminals are placed into a state in which they can be connected to each other.

A radio communication network used in a home may perform ad-hoc communication by which communication terminals can communicate with each other without any intervention of an access point. In such ad-hoc communication, communication terminals can perform radio communication asynchronously directly with each other under the management of the CSMA protocol. Further, in UWB (Ultra Wide Band) communication of IEEE802.15.3, management of a network is performed through an access point, and the ad-hoc communication (or mesh communication) described above is implemented by a data communication method of a packet structure which uses a preamble. Such a network used in a home as just described is hereinafter referred to as home network.

The information processing apparatus 601 and 602 additionally have a function of the content reproduction apparatus 10 described hereinabove and can connect themselves to the copyright management server 20a to acquire content information, link information and so froth from the copyright management server 20a. Further, the information processing apparatus 601 and 602 decrypt and reproduce an encrypted content provided from the content providing server 20b in accordance with the link system described hereinabove.

Further, while each of the information processing apparatus 601 and 602 may be formed as a personal computer, a DVD recorder, an audio apparatus or the like, it is not limited to any of the apparatus just mentioned. The information processing apparatus 601 and 602 can execute a process of information relating to a content provided from the content providing server 20b. The process of information relating to a content may include decryption of the content, verification of a certificate necessary for utilization of the content and compression of music data.

The compression process of music data is a process of compressing, for example, music data recorded on a compact disk into data compressed by a compression coding method such as the ATRAC3 method or the MP3 method described hereinabove. Sound data recorded on a compact disk are digital data of sound recorded, for example, in accordance with the PCM (Pulse Code Modulation) method or the like. The PCM method is one of methods of conversion of sound into digital data and digitizes and records the sound after every fixed interval of time. Sound data recorded on a compact disk are recorded as quantized 16-bit data (sound data are represented with 65,536 stages from 0 to 65,535) sampled with a sampling frequency of 44.1 kHz (44,100 times of digitization for one second).

By compressing sound data recorded on a compact disk in accordance with the ATRAC3 method, MP3 method or the like, the sound data can be compressed into data of a data amount reduced to approximately one tenth while sound quality similar to that of a compact disk is achieved. To extract a digital content (music data, image data or the like) recorded on a recording medium such as a music CD, a video DVD or a software CD-ROM using such a compression method as described above, convert the digital content into a content of a file format with which the content can be processed by an information processing apparatus and then store the content of the format into a storage apparatus or a removable recording medium is called ripping.

Processing of information relating to a content such as ripping described above involves many processes which apply a heavy load to the CPU of the information processing apparatus 601 and 602 and require much processing time. In the present embodiment, for example, where ripping is performed by the information processing apparatus 601, a compression process which applies a heavy load to the CPU can be processed efficiently in a distributed relationship using a self apparatus and another information processing apparatus connected to a home network.

For example, the ratio of processing to be assigned to an information processing apparatus of a destination of request for processing can be determined in response to resource information and the load condition of other information processing apparatus connected to the home network to perform distributed processing with the entire home network taken into consideration. In the following, the information processing apparatus which issues a request for processing to another information processing apparatus is the request source information processing apparatus 601 and an information processing apparatus which makes a destination of the request for processing is the request destination information processing apparatus 602.

The management server 600 is a computer which stores identification information of the information processing apparatus connected to the home network and process types which are types of processing functions, resource information and so forth in an associated relationship with each other. The management server 600 transmits resource information and so forth of the request destination information processing apparatus 602 in response to a request from the request source information processing apparatus 601. The management server 600 may have the functions of the information processing apparatus 601 and 602 such that also it may execute processing of information relating to a content.

The user apparatus (PD) 604 is a portable content reproduction apparatus and may be a portable audio player or the like including a hard disk drive (HDD) having a storage capacity of, for example, several tens GB. The user apparatus (PD) 604 is connected by a USB cable or the like to the information processing apparatus 601 connected to the home network so that it acquires content information through the computer of the information processing apparatus 601. For example, a content ripped by the information processing apparatus 601 is transmitted to the user apparatus (PD) 604 so that the content can be reproduced by the user apparatus (PD) 604. At this time, if the request source information processing apparatus 601 and the user apparatus (PD) 604 are associated with each other by the link system described hereinabove, then they can transmit and receive a content protected under the copyright in safety and the content can be reproduced on the user apparatus (PD) 604.

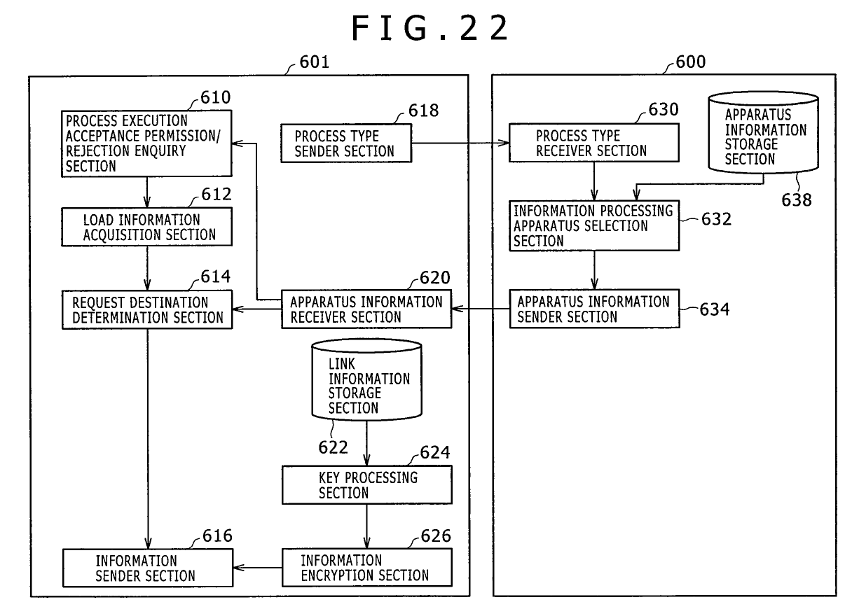

The general configuration of the information process distribution system 500 is such as described above. Now, a functional configuration of the management server 600 and the request source information processing apparatus 601 is described with reference to FIG. 22.

<12. Functional Configuration of the Management Server and the Request Source Information Processing Apparatus>

FIG. 22 shows a functional configuration of the management server and the request source information processing apparatus. The management server 600 includes a process type receiver section 630, an information processing apparatus selection section 632, an apparatus information sender section 634, an apparatus information storage section 638 and so forth.

The process type receiver section 630 receives a type of a process to be requested by the request source information processing apparatus 601 from the request source information processing apparatus 601. The type of a process is a kind of a process to be executed using a function provided for the information processing apparatus and may be, for example, a decryption process, an encryption process, a compression process or the like. Each of the information processing apparatus includes one, two or more processing functions, which may be different from those of the other information processing apparatus.

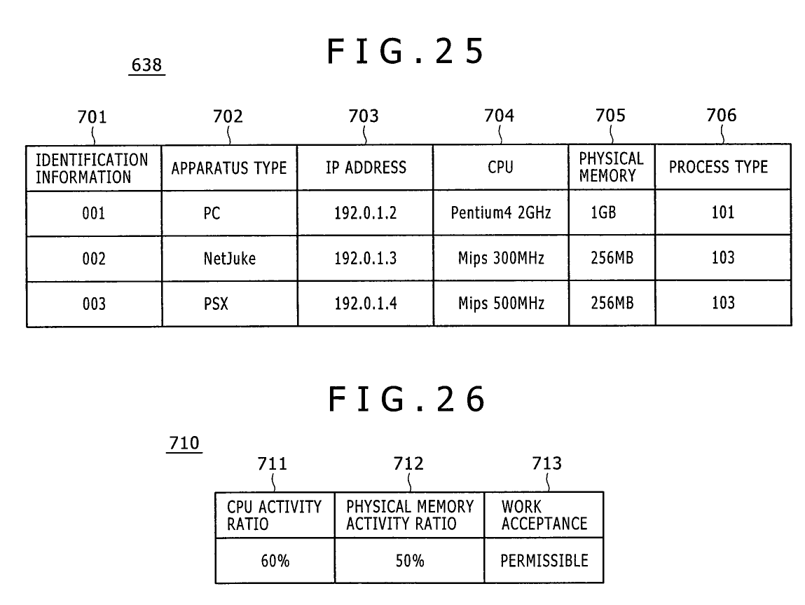

The apparatus information storage section 638 stores identification information, resource information, process types and so forth of the information processing apparatus in an associated relationship with each other. For example, as shown in FIG. 25, the apparatus information storage section 638 includes identification information 701, an apparatus type 702, an IP address 703, a CPU 704, a physical memory 705, a process type 706 and so forth. The identification information 701 indicates information with which each of the information processing apparatus in the home network can be identified uniquely, and may be identification information set in advance and acquired and stored or may be set by the management server 600. The information of each of the information processing apparatus may be stored into the apparatus information storage section 638 every time an information processing apparatus is additionally connected to the network. By the configuration just described, even if the user is not aware, information of the information processing apparatus necessary for distributed processing can be stored and managed in the apparatus information storage section 638.

The CPU 704 indicates information representative of a performance of a CPU. The physical memory 705 indicates information representative of the magnitude of the capacity of a storage apparatus provided in each information processing apparatus. The CPU 704 and the physical memory 705 are referred to also as resource information of the information processing apparatus. The process type 706 indicates information representative of a type of a function provided in each information processing apparatus. As seen in FIG. 25, the process type of an information processing apparatus which includes a function for executing a decryption process and an encryption process may be set as 101 while the process type of another information processing apparatus which includes a function for executing a decryption process, an encryption process and a compression process may be set as 103.

Apparatus information, stored in the apparatus information storage section 638, of the information processing apparatus connected to the home network may be transmitted from the individual information processing apparatus. Further, where, when an information processing apparatus is connected to the home network, apparatus information of the connected information processing apparatus is not stored in the management server 600, the management server 600 may acquire and store the apparatus information of the information processing apparatus. Furthermore, where the resource information or the like of any of the information processing apparatus changes, the apparatus information stored in the apparatus information storage section 638 may be updated.

Referring back to FIG. 22, the information processing apparatus selection section 632 selects an information processing apparatus in accordance with a process type received from the process type receiver section 630 from among the information processing apparatus stored in the apparatus information storage section 638 and acquires the identification information 701 of the selected information processing apparatus. For example, if the process type 706 transmitted from the request source information processing apparatus 601 is “103”, then the information processing apparatus selection section 632 acquires the identification information 701 of an information processing apparatus in which the process type 706 of the apparatus information storage section 638 is “103”. In this instance, the process type 706 is “103” with regard to two information processing apparatus, which have identification information of “002” and “003”.

The apparatus information sender section 634 transmits the identification information of an information processing apparatus selected by the information processing apparatus selection section 632 and apparatus information associated with the identification information to the request source information processing apparatus 601. For example, where the identification information 701 of the information processing apparatus selected by the information processing apparatus selection section 632 is “002” and “003”, the apparatus information sender section 634 transmits the CPU 704 and the physical memory 705 of the apparatus information of those information processing apparatus. At this time, the apparatus information sender section 634 may transmit the apparatus information of the other information processing apparatus than the request source information processing apparatus 601.

The request source information processing apparatus 601 includes a process execution acceptance permission/rejection enquiry section 610, a load information acquisition section 612, a request destination determination section 614, and an information sender section 616. The request source information processing apparatus 601 further includes a process type sender section 618, an apparatus information receiver section 620, a link information storage section 622, a key processing section 624, an information encryption section 626 and so forth.

The process type sender section 618 transmits a process type to the management server 600. The type is a type of a processing function necessary to execute a process relating to a content and is information representative of a type of a process such as a decryption process or an encryption process. The apparatus information receiver section 620 receives identification information and apparatus information of the request destination information processing apparatus 602, which makes a request destination of a process, having a function designated depending upon the process type and provides the received identification information and apparatus information to the process execution acceptance permission/rejection enquiry section 610 and the request destination determination section 614.

The process execution acceptance permission/rejection enquiry section 610 issues an enquiry about whether or not execution of a process is acceptable to the request destination information processing apparatus 602 of the identification information provided from the apparatus information receiver section 620. Then, the process execution acceptance permission/rejection enquiry section 610 provides a result of the enquiry to the request destination information processing apparatus 602 to the load information acquisition section 612. The load information acquisition section 612 acquires load information at present of the request destination information processing apparatus 602 which can accept execution of the process, and provides the load information to the request destination determination section 614. The load information here is a CPU utilization factor or a memory utilization factor of the request destination information processing apparatus 602. The load information acquisition section 612 may further acquire and provide a transmission line capacity to the request destination information processing apparatus 602, transmission line load information determined by execution of a ping or the like to the request destination determination section 614.

The request destination determination section 614 determines a request destination of a process including the self apparatus from the load information of the request destination information processing apparatus 602 provided from the load information acquisition section 612, an estimated transfer time period determined from the transmission line load information and so froth. Further, the request destination determination section 614 may determine a ratio at which the process should be executed.

For example, where a process for compressing sound data recorded on a compact disk is to be executed, it is determined by what ratio the process of compressing music data recorded in accordance with the PCM method or the like on the compact disk should be assigned to the request destination information processing apparatus 602. Where the compact disk has music data for 10 tunes recorded thereon, the request destination determination section 614 may determine such that four tunes should be compressed by the self apparatus while a request to perform the compression process for the remaining six tunes is to be issued to the request destination information processing apparatus 602.

The link information storage section 622 and the key processing section 624 have functions similar to those of the link information storage section 548 and the key processing section 552, respectively, and therefore, overlapping description of the functions is omitted herein to avoid redundancy.

The information encryption section 626 acquires the user key unique to the user who owns the request source information processing apparatus 601 and acquired by the key processing section 624, and encrypts the information relating to the content with the acquired user key. For example, where data recorded on a compact disk are an object of a process to be requested, the information encryption section 626 encrypts the data. Where the data recorded on the compact disk are music data, when the data are encrypted, they may be encrypted for every tune. The data encrypted for each tune are provided to the information sender section 616.

The information sender section 616 divides the data encrypted by the information encryption section 626 at the ratio determined by the request destination determination section 614 and transmits the divided data to the request destination information processing apparatus 602. For example, where the music data are encrypted for the individual tunes as described above, the information sender section 616 may transmit the data for the four tunes from among the 10 tunes in response to the resource information and the load information of the request destination information processing apparatus 602 and request the request destination information processing apparatus 602 to perform a compression process for the data.

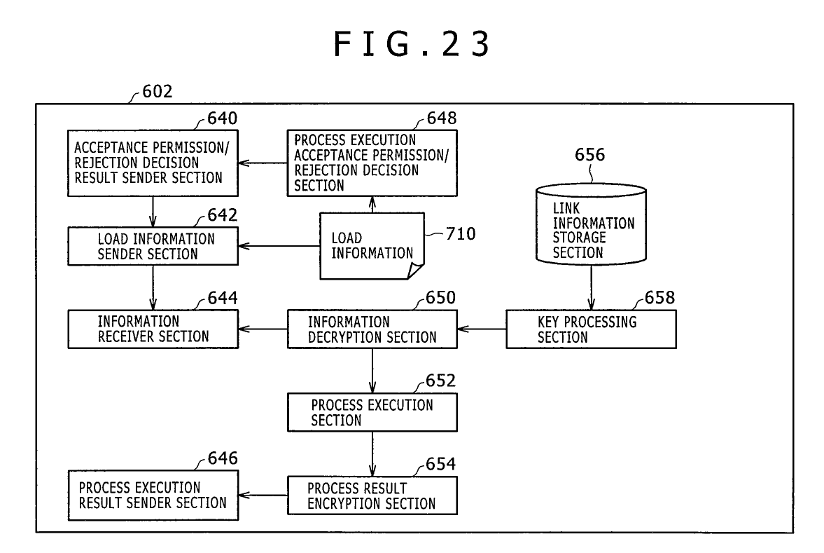

The management server 600 and the request source information processing apparatus 601 have such a functional configuration as described above. Now, a functional configuration of the request destination information processing apparatus 602 which is a request destination of a process is described with reference to FIG. 23.

<13. Functional Configuration of the Request Destination Information Processing Apparatus>

FIG. 23 shows a functional configuration of the request destination information processing apparatus 602. The request destination information processing apparatus 602 includes an acceptance permission/rejection decision result sender section 640, a load information sender section 642, an information receiver section 644, and a process execution result sender section 646. The request destination information processing apparatus 602 further includes a process execution acceptance permission/rejection decision section 648, load information 710, an information decryption section 650, a process execution section 652, a process result encryption section 654, a link information storage section 656, a key processing section 658 and so forth.

The process execution acceptance permission/rejection decision section 648 refers, when an inquiry about whether or not execution of a process is acceptable is received from the request source information processing apparatus 601, to the load information 710 to decide whether or not the self apparatus can accept the process of the request source information processing apparatus 601. As seen in FIG. 26, the load information 710 includes a CPU activity ratio 711 of the request destination information processing apparatus 602, a physical memory activity ratio 712, a work acceptance 713 and so forth. The process execution acceptance permission/rejection decision section 648 acquires work acceptance permission/rejection information of the work acceptance 713 included in the load information 710 and transmits a result of the acquisition to the acceptance permission/rejection decision result sender section 640.

The acceptance permission/rejection decision result sender section 640 transmits a process execution acceptance permission/rejection decision result provided by the process execution acceptance permission/rejection decision section 648 to the request source information processing apparatus 601. The load information sender section 642 transmits, when it receives an enquiry about load information from the request source information processing apparatus 601, a use situation of resources such as the CPU activity ratio 711 and the physical memory activity ratio 712 included in the load information 710 to the request source information processing apparatus 601.

The information receiver section 644 receives information, which makes an object of the request process, transmitted from the request source information processing apparatus 601 and provides the received information to the information decryption section 650. Where the information, which makes an object of the request process, provided from the information receiver section 644 is in an encrypted form, the information decryption section 650 uses a user key unique to the user who uses the request source information processing apparatus 601 and received from the key processing section 658 to decrypt the information of the object of the process.

The link information storage section 656 and the key processing section 658 have functions substantially similar to those of the link information storage section 548 and the key processing section 552 described hereinabove, respectively, and therefore, overlapping description of the functions is omitted herein to avoid redundancy. As described hereinabove, information relating to a content which makes an object of a process is transmitted after it is encrypted with the user key of the user who uses the request source information processing apparatus 601. The users who use the request source information processing apparatus 601 and the request destination information processing apparatus 602 connected to each other by the home network are same person, and the request source information processing apparatus 601 and the request destination information processing apparatus 602 are associated with each other by the link system described hereinabove. Accordingly, the user keys stored in the request source information processing apparatus 601 and the request destination information processing apparatus 602 are same as each other, and information can be communicated in safety between the information processing apparatus 601 and 602 if, for example, the common key of the user is used to perform encryption and decryption.

The process execution section 652 processes information decrypted by the information decryption section 650. For example, if music data are transmitted and a request for a compression process of the music data is issued, then the process execution section 652 executes a compression process of the music data. The process result encryption section 654 encrypts a result of the process by the process execution section 652 with the user key.

The process execution result sender section 646 transmits a result of the process encrypted by the process result encryption section 654 to the request destination information processing apparatus 602. Also here, the common key of the user can be used to encrypt and decrypt a result of the process in accordance with the private key cryptography and transmit and receive the information in safety.

According to the information process distribution system 500 described above, when a process which provides a heavy load and requires much time is to be executed, the process can be distributed efficiently taking resource information and load information of a plurality of information processing apparatus connected to each other by a home network into consideration. Further, since the information processing apparatus connected to the home network are associated with each other by the link system, information of an object of a request can be transmitted and received in safety using the user key stored in each information processing apparatus. In other words, a distribution process is achieved while the copyright of a content of an object of a request is protected.

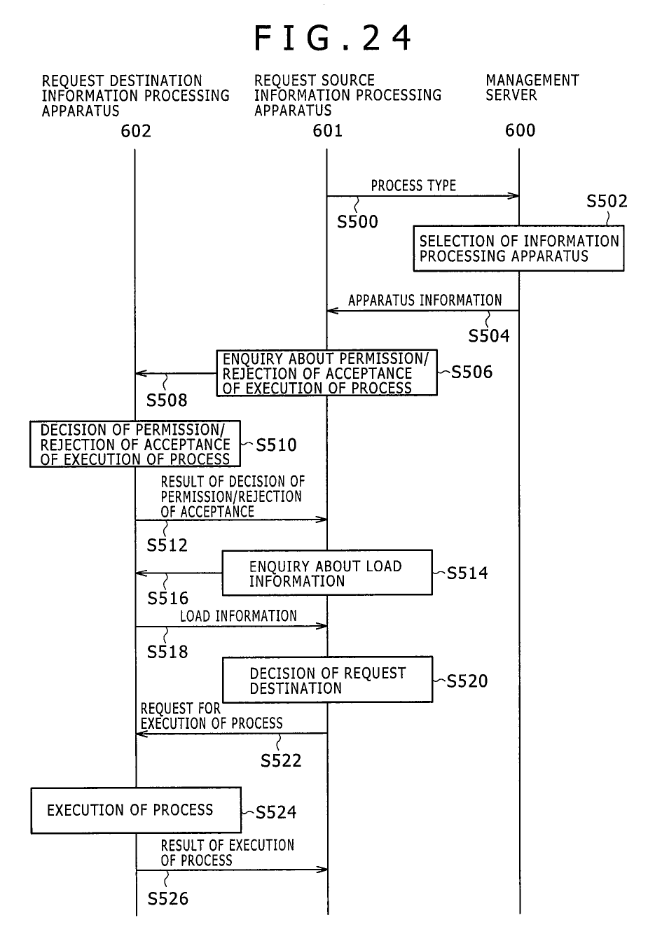

The request destination information processing apparatus 602 has such a functional configuration as described above. Now, a method of performing a distribution method of information relating to a content is described with reference to FIG. 24.

<14. Distributed Processing Method of Information Relating to a Content>

First, the request source information processing apparatus 601 transmits a type of a process to the management server 600 (step S500). The management server 600 to which the process type is transmitted from the request source information processing apparatus 601 at step S500 selects an information processing apparatus which has the received process type (step S502). Further, the management server 600 acquires identification information of the information processing apparatus having the received process type and apparatus information of the information processing apparatus associated with the identification information.

The identification information and the apparatus information of the information processing apparatus selected at step S502 are transmitted to the request source information processing apparatus 601 (step S504). The request source information processing apparatus 601 which acquires the identification information and the apparatus information of the request destination information processing apparatus which makes a request destination of the process at step S504 issues an enquiry about whether or not execution of the process is acceptable to the request destination information processing apparatus 602 based on the identification information (step S506).

The request destination information processing apparatus 602 which receives the inquiry about whether or not execution of the process is acceptable from the request source information processing apparatus 601 at step S508 decides whether or not execution of the process is acceptable (step S510). A result of the decision made at step S510 of whether or not execution of the process is acceptable is transmitted to the request source information processing apparatus 601 (step S512).

The request source information processing apparatus 601 which receives the result of the decision of whether or not execution of the process is acceptable from the request destination information processing apparatus 602 at step S512 issues an enquiry about load information at present to the request destination information processing apparatus 602 which can accept execution of the process (step S514). The request destination information processing apparatus 602 which receives the enquiry about load information at step S516 transmits load information such as the activity ratio of the CPU at present or the activity ratio of the physical memory to the request source information processing apparatus 601 (step S518).

The request source information processing apparatus 601 which receives the load information of the request destination information processing apparatus 602 at step S518 determines the request destination of the process and the ratio of the process taking the resource information and the load information of the information processing apparatus connected to the home network including the self apparatus, the transmission line capacity to the other information processing apparatus and so forth into consideration (step S520). An execution request of the process and information relating to the content corresponding to the ratio of the process are encrypted and transmitted to the request destination of the process determined at step S520 (step S522).

The request destination information processing apparatus 602 which receives the execution request of the process from the request source information processing apparatus 601 at step S522 executes the requested process (step S524). A result of the process executed at step S524 is transmitted to the request source information processing apparatus 601 (step S526). At step S526, the information relating to the processed content is encrypted by the request destination information processing apparatus 602 and then transmitted. At step S526, the request source information processing apparatus 601 may re-check the ratio of the process request taking an actual work response time period into consideration after it receives a result of the execution of the process.

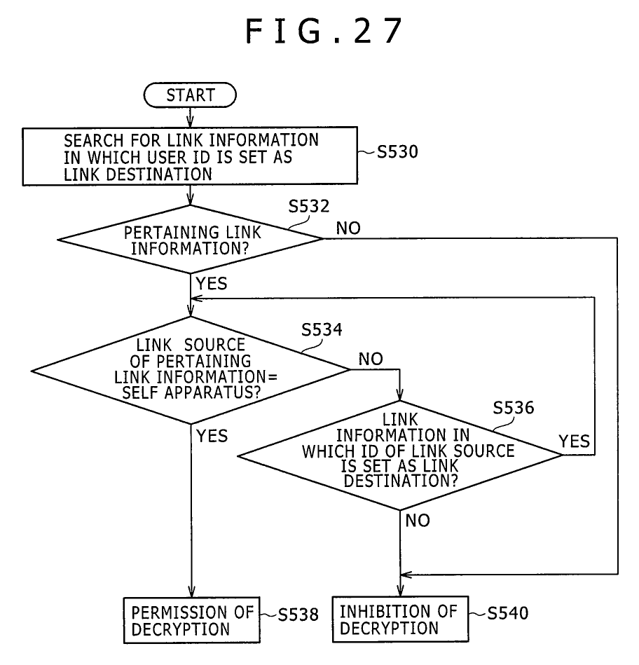

The method of performing a distribution process of information relating to a content is such as described above. Now, a method executed by the request destination information processing apparatus 602 of decrypting information relating to a content encrypted with the user key is described with reference to FIG. 27.

<15. Decryption Method of Information Relating to a Content>

FIG. 27 illustrates a method executed by the request destination information processing apparatus 602 of decrypting information relating to a content encrypted with a user key. The information relating to a content encrypted with a user key includes identification information of the user.

First, the request destination information processing apparatus 602 checks whether or not the user ID included in the acquired information relating to a content is stored in the link information storage section 656. If the user ID is stored in the link information storage section 656, then the request destination information processing apparatus 602 checks based on the link information whether or not a route whose starting point is the self apparatus and whose arriving point is the user ID is produced in the link information storage section 656. In other words, the request destination information processing apparatus 602 searches the link information storage section 656 for link information (for example, the link A) in which the user ID included in the content information is set as the link destination (step S530).

If the link information is searched out (at step S532), then the request destination information processing apparatus 602 decides whether or not the identification information set as the link source of the link A is the device ID of the self apparatus (step S534). If the link source of the link A is the device ID of the self apparatus, then the request destination information processing apparatus 602 decides that a route whose starting point is the self apparatus and whose arriving point is the user ID is produced and permits a decryption process of the content key by the information decryption section 650 (step S538).

If the link source of the link A is not the device ID of the self apparatus at step S534, then the request destination information processing apparatus 602 searches for different link information (for example, the link B) in which the identification information of the link destination of the link A is set as the link destination (step S536). If the pertaining link information is not searched out, then the request destination information processing apparatus 602 decides that a route whose starting point is the self apparatus and whose arriving point is the user ID is not produced and does not permit a decryption process of the content key by the information decryption section 650 (step S540). On the other hand, if the pertaining link information is searched out at step S536, then the request destination information processing apparatus 602 decides whether or not the identification information set as the link source of the link B is the device ID of the self apparatus (step S534).

The processes described above are repeated to trace the link information, and if the link information in which the device ID of the self apparatus is set as the link source is stored in the link information storage section 656, then a decryption process of the content key is permitted. The method of decrypting information relating to a content key encrypted with the user key is such as described above.

With the information process distribution system 500 according to the present embodiment, in environment wherein a plurality of information processing apparatus which process information relating to a plurality of contents are connected to each other, calculation resources of the information processing apparatus can be utilized efficiently without urging the user to perform cumbersome operations. Further, a content protected by the copyright or information relating to the content can be transmitted and received in safety between the information processing apparatus connected to a home network. In the present embodiment, information relating to a content which can be decrypted only by those information processing apparatus which are linked to the user who owns the information processing apparatus can be transmitted and received. In other words, even if the information relating to the content is transmitted to an information processing apparatus which is not linked to the user, the information processing apparatus cannot decrypt the information relating to the content. Consequently, the information relating to the content is prevented from being utilized beyond the authorized limit of rights of utilization provided to the user. Accordingly, while the copyright of the content is protected, a distribution process can be achieved efficiently.

While a preferred embodiment of the present invention has been described with reference to the accompanying drawings, naturally the present invention is not limited to the specific embodiments. It is apparent that those skilled in the art could make various alterations or modifications within the spirit and scope of the present invention as set forth in the claims, and naturally such alterations and modifications shall fall within the technical scope of the present invention.

While, in the embodiment described hereinabove, apparatus information of the information processing apparatus connected to the home network is stored in the management server 600, the present invention is not limited to the specific configuration. For example, the information processing apparatus may each store apparatus information of those information processing apparatus which are connected to the self apparatus. Further, where the apparatus information is not stored, every time a process is executed, apparatus information of those information processing apparatus which are connected to the self apparatus may be acquired. By the configuration just described, it is possible for an information processing apparatus which serves as a request source to issue an enquiry about apparatus information of a different information processing apparatus directly to the different information processing apparatus as in a PtoP system without providing the management server 600.

The present invention can be applied to an information process distribution system wherein information relating to a content is processed in a distributed manner by a plurality of information processing apparatus.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information process distribution system, comprising:
a management server; and
a plurality of information processing apparatus connected to said management server through a communication network for processing information relating to a content;
said management server including
an apparatus information storage section for storing identification information of said information processing apparatus and apparatus information in an associated relationship with each other, the apparatus information including at least process types which can be executed individually by said information processing apparatus and resource information of said information processing apparatus,
an information processing apparatus selection section for selecting one of said information processing apparatus suitable for a process type designated by a request source one of said information processing apparatus which issues a request to execute a process of information relating to a content and acquiring identification information of the selected information processing apparatus from said apparatus information storage section, and
an apparatus information sender section for transmitting the identification information of the selected information processing apparatus acquired by said information processing apparatus selection section and the apparatus information associated with the identification information;
the request source information processing apparatus including
a process type sender section for transmitting a process type necessary to execute a process of information relating to a content,
an apparatus information receiver section for receiving the identification information of the information processing apparatus selected by said management server and the apparatus information associated with the identification information,
a load information acquisition section for acquiring load information of the selected information processing apparatus based on the identification information of the selected information processing apparatus received by said apparatus information receiver section,
a request destination determination section for determining a request destination one of said information processing apparatus to which a request to execute a process is to be issued based on the resource information included in the apparatus information and the load information, and
a content information sender section for issuing a request to execute the process to the request destination information processing apparatus and transmitting information relating to the content of an object of the process to be requested;
the request destination information processing apparatus including
a load information sender section for transmitting load information of the request destination information processing apparatus to the request source information processing apparatus,
a process execution section for executing the process of the information relating to the content requested by the request source information processing apparatus, and
a process execution result sender section for transmitting a result of the execution of the process executed by said content process execution section to the request source information processing apparatus.

2. An information processing apparatus connected through a communication network to a management server and different information processing apparatus which process information relating to a content, comprising:
a process type sender section for transmitting a process type necessary to execute a process of information relating to a content;
an apparatus information receiver section for receiving identification information of one, two or more of said different information processing apparatus suitable for the process type and apparatus information associated with the identification information and including at least resource information of the different information processing apparatus;
a load information acquisition section for acquiring, based on the identification information of the different information processing apparatus received by said apparatus information receiver section, load information of the different information processing apparatus;
a request destination determination section for determining a request destination one of the different information processing apparatus to which a request to execute a process is to be issued based on the resource information included in the apparatus information and the load information; and
an information sender section for issuing a request to execute the process to the request destination information processing apparatus and transmitting information relating to the content of an object of the process to be requested.

3. The information processing apparatus according to claim 2, wherein said management server stores identification information of said different information processing apparatus and apparatus information in an associated relationship with each other, the apparatus information including process types which can be executed individually by at least those of said different information processing apparatus which are associated with the identification information and resource information of the different information processing apparatus, and said management server selects one of the different information processing apparatus suitable to the process type transmitted from said process type sender section and transmits the identification information of the selected information processing apparatus.

4. The information processing apparatus according to claim 2, further comprising a process execution acceptance permission/rejection enquiry section for issuing an enquiry about whether or not execution of the process of information relating to the content is acceptable to the different information processing apparatus associated with the identification information of the different information processing apparatus received by said apparatus information receiver section, said load information acquisition section acquiring load information of the different information processing apparatus which can accept execution of the process of information relating to the content.

5. The information processing apparatus according to claim 2, wherein said request destination determination section determines an execution ratio of the process and that one of the different information processing apparatus to which a request for the process according to the execution ratio is to be issued based on the resource information included in the apparatus information and the load information, and said information sender section issues a request for execution of the process to the determined different information processing apparatus and transmits information relating to the content of the object of the process according to the execution ratio.

6. The information processing apparatus according to claim 2, further comprising an information encryption section for encrypting the information relating to the content of the object of the process to be requested with a user key unique to a user who uses said information processing apparatus, said information sender section transmitting the information relating to the content and encrypted by said information encryption section.

7. The information processing apparatus according to claim 6, further comprising:
a link information storage section for storing identification information of said information processing apparatus and identification information of the user who uses said information processing apparatus in an associated relationship with each other;
said link information storage section storing an encrypted user key unique to the user who uses said information processing apparatus; and
a key processing section for decrypting the encrypted user key using a device key unique to said information processing apparatus;
said information encryption section encrypting the information relating to the content with the user key unique to the user and decrypted by said key processing section.

8. The information processing apparatus according to claim 6, wherein said link information storage section stores at least one piece of link information and produces, in accordance with the stored link information, a route whose starting point is said information processing apparatus identified with the identification information and whose arriving point is the user identified with the identification information to implement the association between the identification information of said information processing apparatus and the identification information of the user who uses said information processing apparatus, the link information including a pair of pieces of identification information one of which represents a link source and the other one of which represents a link destination.

9. An information processing apparatus connected through a communication network to a different information processing apparatus which issues a request to process information relating to a content, comprising:
a load information sender section for transmitting load information of said information processing apparatus to said different information processing apparatus;
a process execution section for executing the process of the information relating to the content requested by said different information processing apparatus; and
a process execution result sender section for transmitting a result of the execution of the process executed by said content process execution section to said different information processing apparatus.

10. The information processing apparatus according to claim 9, further comprising:
a process execution acceptance permission/rejection decision section for deciding whether or not execution of the process of information relating to the content requested by said different information processing apparatus is acceptable; and
an acceptance permission/rejection decision result sender section for transmitting a result of the acceptance permission/rejection decision decided by said process execution acceptance permission/rejection decision section to said different information processing apparatus;
said load information sender section transmitting load information of said information processing apparatus when it is decided by said process execution acceptance permission/rejection decision section that execution of the process of information is acceptable.

11. The information processing apparatus according to claim 9, further comprising:
an information receiver section for receiving information relating to a content of an object of processing encrypted with a user key unique to a user who uses said different information processing apparatus by said different information processing apparatus; and
an information decryption section for decrypting the information relating to the encrypted content;
said process execution section executing the process of the information relating to the content and decrypted by said information decryption section.

12. The information processing apparatus according to claim 9, further comprising a process execution result encryption section for encrypting a process execution result of the process executed by said process execution section with a user key unique to a user who uses said information processing apparatus, said process execution result sender section transmitting the process execution result encrypted by said process execution result encryption section.

13. The information processing apparatus according to claim 9, further comprising a link information storage section for storing identification information of said information processing apparatus and identification information of a user who uses said information processing apparatus, said content decryption section successfully decrypting the encrypted information relating to the content when the identification information of the user stored in said link information storage section and identification information of a user who uses said different information processing apparatus are associated.

14. The information processing apparatus according to claim 13, further comprising:
a link information storage section for storing identification information of said information processing apparatus and identification information of the user who uses said information processing apparatus in an associated relationship with each other;
said link information storage section storing an encrypted user key unique to the user who uses said information processing apparatus; and
a key processing section for decrypting the encrypted user key using a device key unique to said information processing apparatus;
said information decryption section decrypting the encrypted information relating to the content with the user key decrypted by said key processing section.

15. The information processing apparatus according to claim 13, wherein said link information storage section stores at least one piece of link information and produces, in accordance with the stored link information, a route whose starting point is said information processing apparatus identified with the identification information and whose arriving point is the user identified with the identification information to implement the association between the identification information of said information processing apparatus and the identification information of the user who uses said information processing apparatus, the link information including a pair of pieces of identification information one of which represents a link source and the other one of which represents a link destination.

16. An information processing distribution method for an information processing apparatus, comprising the steps of:
transmitting a process type necessary to execute a process of information relating to a content;
receiving identification information of one, two or more of different information processing apparatus suitable for the process type and apparatus information associated with the identification information and including at least resource information of said different information processing apparatus;
acquiring, based on the identification information of said different information processing apparatus received by the apparatus information reception step, load information of said different information processing apparatus;
determining a request destination one of said different information processing apparatus to which a request to execute a process is to be issued based on the resource information included in the apparatus information and the load information; and
issuing a request to execute the process to the request destination information processing apparatus and transmitting information relating to the content of an object of the process to be requested.

17. An information processing distribution method for an information processing apparatus, comprising the steps of:
transmitting load information of said information processing apparatus to a different information processing apparatus connected to said information processing apparatus through a communication network;
executing a process of information relating to a content requested by said different information processing apparatus; and
transmitting a result of the execution of the process executed by the content process execution step to said different information processing apparatus.
